(19) United States
(12) Patent Application Publication
(10) Pub. No.: US 2025/0096271 A1
(43) Pub. Date: Mar. 20, 2025

(54) ELECTRODE BINDER COMPRISING CATIONIC SEMI-IPN POLYMER, ELECTRODE AND CELL COMPRISING THE SAME

(71) Applicant: UIF (UNIVERSITY INDUSTRY FOUNDATION), YONSEI UNIVERSITY, Seoul (KR)

(72) Inventors: Sang-Young LEE, Seoul (KR); Jung-Hui KIM, Seoul (KR)

(73) Assignee: UIF (UNIVERSITY INDUSTRY FOUNDATION), YONSEI UNIVERSITY, Seoul (KR)

(21) Appl. No.: 18/830,778

(22) Filed: Sep. 11, 2024

(30) Foreign Application Priority Data
Sep. 14, 2023 (KR) 10-2023-0122383
Jul. 22, 2024 (KR) 10-2024-0096134

(51) Int. Cl. H01M 4/62; H01M 4/04

(52) U.S. Cl. CPC H01M 4/622; H01M 4/0404; H01M 4/0471; H01M 2220/20; H01M 2220/30

(57) ABSTRACT

The present invention relates to an electrode binder containing a cationic semi-interpenetrating network polymer, as well as to electrodes and batteries incorporating such binder. The electrode binder of the present invention can enhance both the physical properties (dispersion, flexibility, and adhesion) and the electrochemical properties (performance, charge/discharge, and lifespan) of the electrodes.

### CROSS-REFERENCE TO RELATED APPLICATION

This application claims priority to Korean Patent Application No. 10-2023-0122383, filed on Sep. 14, 2023, and Korean Patent Application Nos. 10-2024-0096134, filed Jul. 22, 2024, and all the benefits accruing therefrom under 35 U.S.C. § 119, the contents of which are herein incorporated by reference in their entirety.

### BACKGROUND

The present invention relates to an electrode binder comprising a cationic semi-interpenetrating network polymer, as well as an electrode and a battery that include such binder.

The promising potential of future innovative electronic devices, electric vehicles, and grid-scale energy storage systems is driving the continuous demand for high-energy-density lithium batteries. In addition to ongoing research into advanced electrode active materials, designing high areal capacity (C/A) electrodes is gaining attention as a straightforward and scalable approach to increasing the energy density of batteries without the need to synthesize new electrode active materials. This method is considered an effective strategy for achieving higher energy densities in batteries.

To achieve high C/A electrodes (where C/A=areal mass loading (M/A)×specific capacity of the electrode active material (Csp)), it is essential to maximize M/A while maintaining Csp at stable levels. However, traditional electrodes have struggled to meet these requirements due to physical challenges with thick electrodes and electrochemical issues related to uneven charge transfer across the electrode. Specifically, during the fabrication of thick electrodes, the drying of processing solvents like N-methyl-2-pyrrolidone (NMP) and water often leads to cracking and delamination from the metal current collector, thereby limiting the increase in M/A values. Moreover, as electrode thickness increases, charge transfer within the electrode active material tends to become uneven along the thickness direction, leading to slower reaction rates and a subsequent loss in Csp values.

To address these challenges, previous research on high C/A electrodes has largely relied on mechanical pressing and fabrication techniques such as freeze-drying, infiltration, and phase inversion. While these methods have improved the apparent M/A values, they have often failed to maintain Csp, thereby hindering the achievement of meaningful C/A values. Additionally, these physical architecture-based approaches frequently require complex and costly manufacturing processes, making it difficult to scale the research findings beyond the laboratory level. Therefore, to develop practically scalable high C/A electrodes, it is essential to explore new material chemistries that are compatible with commercial slurry-cast electrode manufacturing processes.
Patent Document 1. Korean Registered Patent 10-2661643

The present invention has been conceived to address the aforementioned challenges. The primary objective of the invention is to provide a binder for secondary battery electrodes, which includes a cationic semi-interpenetrating network polymer (semi-IPN).

The present invention also aims to provide an electrode that includes the aforementioned binder for secondary battery electrodes.

In addition, the present invention aims to provide a secondary battery that includes the aforementioned electrode.

Furthermore, the present invention aims to provide a device that includes the aforementioned battery, wherein the device is selected from among communication devices, transportation devices, and energy storage devices.

Moreover, the present invention aims to provide a method for manufacturing a secondary battery electrode, which includes: (a) preparing an electrode slurry by mixing a binder and an electrode active material in a solvent; and (b) applying the electrode slurry to obtain an electrode. The binder used in this method comprises a cationic monomer, a crosslinkable monomer with multifunctional groups, and a linear polymer.

One aspect of the present invention relates to a binder for secondary battery electrodes, which includes a cationic semi-interpenetrating network polymer (semi-IPN). Another aspect of the present invention relates to an electrode that includes the aforementioned binder for secondary battery electrodes.

Still another aspect of the present invention relates to a secondary battery comprising the electrode.

Yet another aspect of the present invention relates to a device comprising the battery, wherein the device is selected from the group consisting of a communication device, a transportation device, and an energy storage device.

A further aspect of the present invention relates to a method for manufacturing an electrode for a secondary battery, comprising: (a) preparing an electrode slurry by adding a binder and an electrode active material to a solvent; and (b) obtaining an electrode by applying the electrode slurry, wherein the binder comprises a cationic monomer, a polyfunctional crosslinkable monomer, and a linear polymer.

The electrode binder containing the cationic semi-interpenetrating network polymer of the present invention can enhance the physical properties of the electrode (such as dispersibility, toughness, and adhesion) as well as the electrochemical properties (such as output, charging, and cycle life characteristics).

The effects of the present invention are not limited to those mentioned above. It should be understood that the effects of the present invention include all effects that can be inferred from the following description.

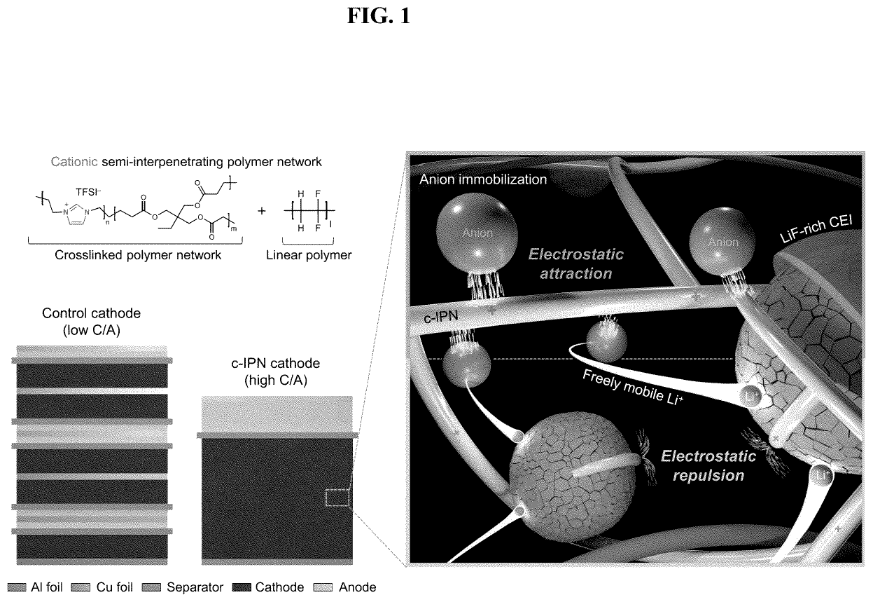

FIG. 1 is a schematic diagram showing the chemical formula of the cationic semi-interpenetrating network polymer (c-IPN) according to one embodiment of the present invention, illustrating the superiority of a cathode with a high area capacity (C/A) according to one embodiment of the present invention compared to a control cathode with a low area capacity (C/A) at the same cell capacity, and a schematic diagram depicting the control of electrostatic phenomena by the binder according to one embodiment of the present invention.

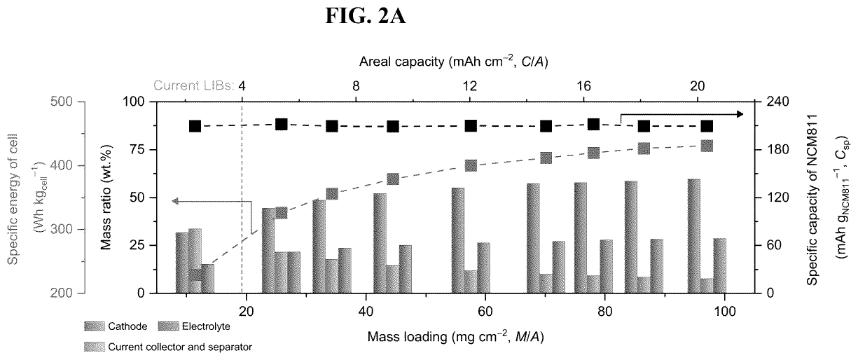

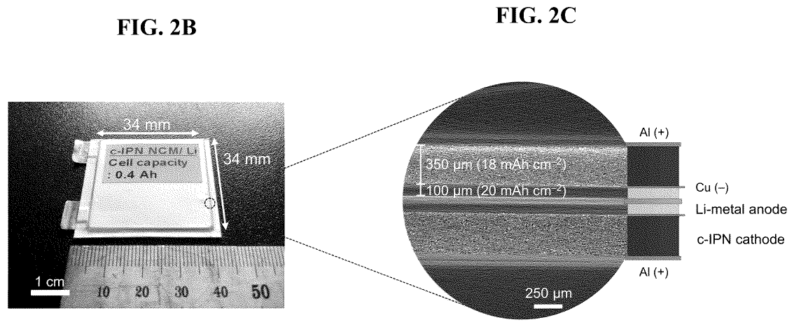

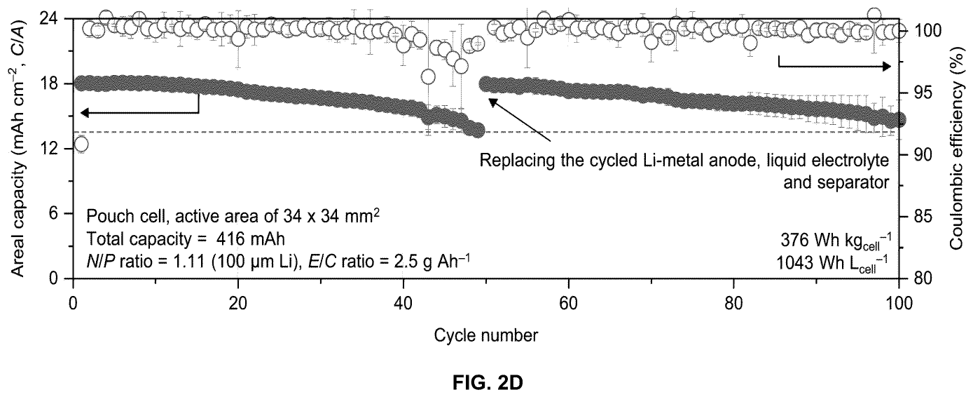

FIGS. 2A to 2D illustrate the following: (2A) a graph showing the specific energy of the NCM811 battery and the specific capacity of the electrode active material (Cₛₚ) when varying the areal mass loading (M/A) of the electrode cathode manufactured in Example 1 (c-IPN) of the present invention; (2B) a photographic image of a double-layer pouch cell using the electrode cathode (C/A=18 mAh cm⁻²) manufactured in Example 1 (c-IPN); (2C) an X-ray micro-computed tomography image showing the cross-sectional structure of the cell; and (2D) the cycling performance at 25° C., with a charge/discharge current density of 0.9 mA cm^{-2/1.8} mA cm⁻², and a voltage range of 3.0-4.4 V.

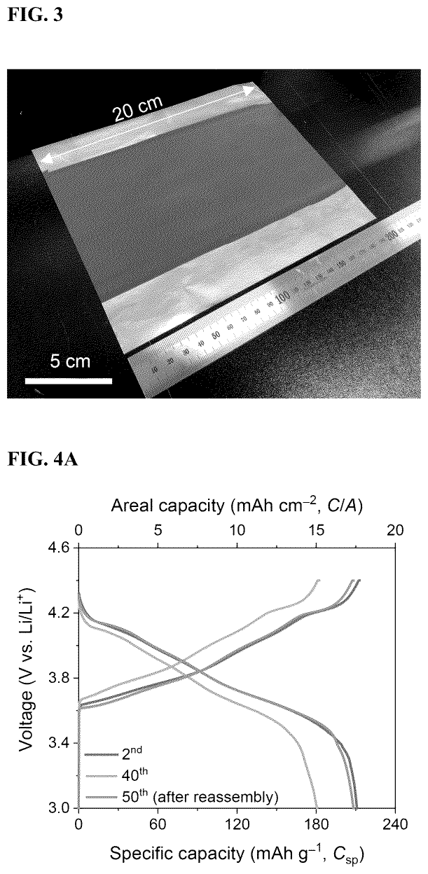

FIG. 3 is a photographic image of a double-layer pouch-type full cell containing the electrode cathode (C/A=18 mAh cm⁻²) manufactured in Example 1 (c-IPN) of the present invention.

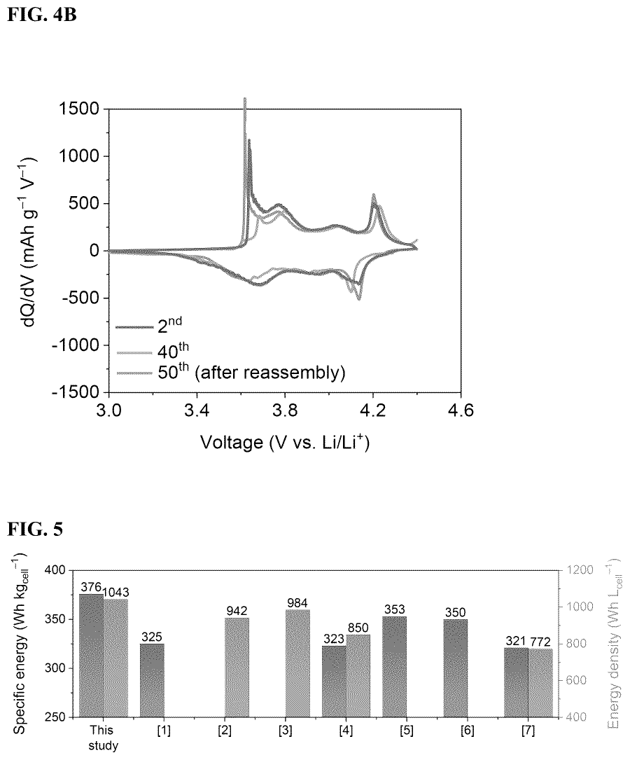

FIGS. 4A and 4B illustrate (A) the constant current charge/discharge profiles at the 2nd, 40th, and 50th cycles, and (B) the corresponding dQ/dV plots of the double-layer pouch cell using the electrode cathode manufactured in Example 1 (c-IPN) of the present invention.

FIG. 5 presents a comparison of the specific energy and energy density between the high-energy density pouch cell using the electrode cathode manufactured in Example 1 (c-IPN) of the present invention and the previously reported high-energy density pouch cells.

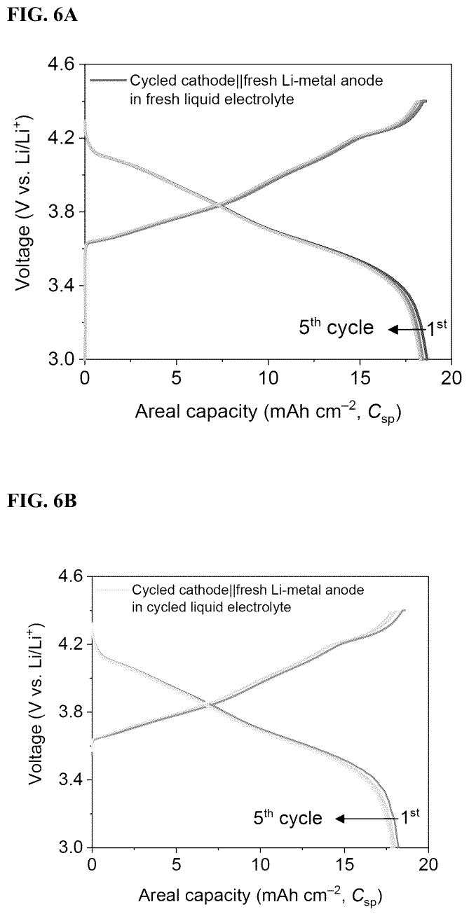

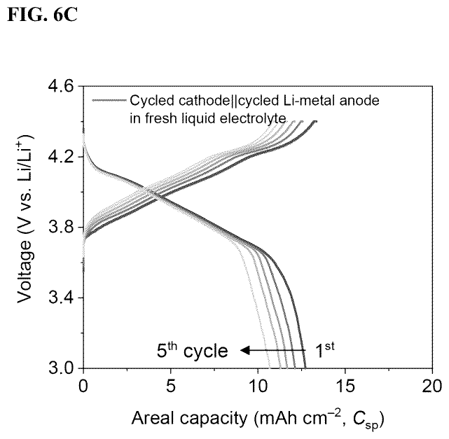

FIGS. 6A to 6C illustrates the constant current charge/discharge profiles from Experimental Example 1 of the present invention for the following cells: (A) Cell #1 (cycled cathode∥fresh liquid electrolyte with a new Li-metal anode), (B) Cell #2 (cycled cathode∥cycled liquid electrolyte with a new Li-metal anode), and (C) Cell #3 (cycled cathode in fresh liquid electrolyte∥cycled Li-metal anode).

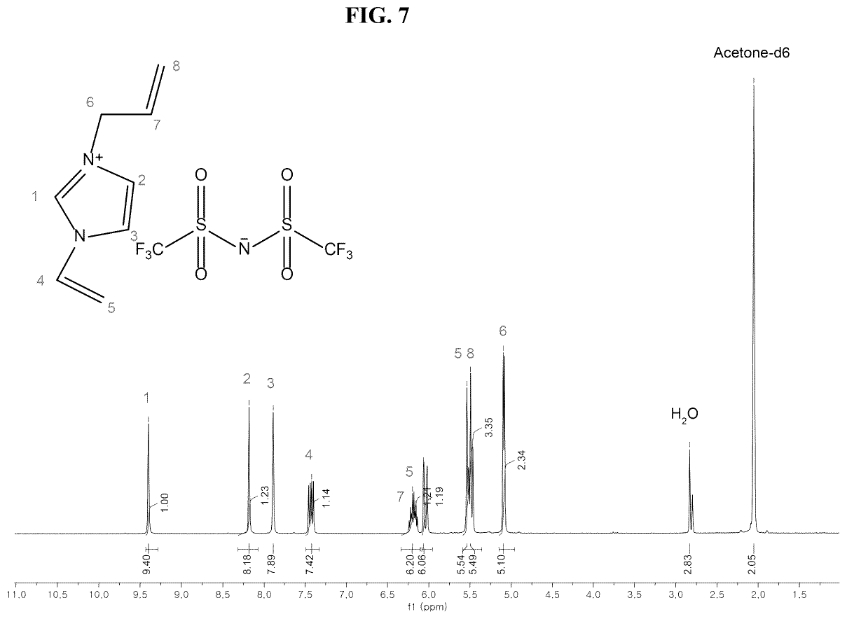

FIG. 7 presents the ¹H nuclear magnetic resonance (NMR) spectrum and chemical structure of 1-vinyl-3-allylimidazolium bis(trifluoromethanesulfonyl)imide (VAI-TFSI) synthesized in Example 1 of the present invention.

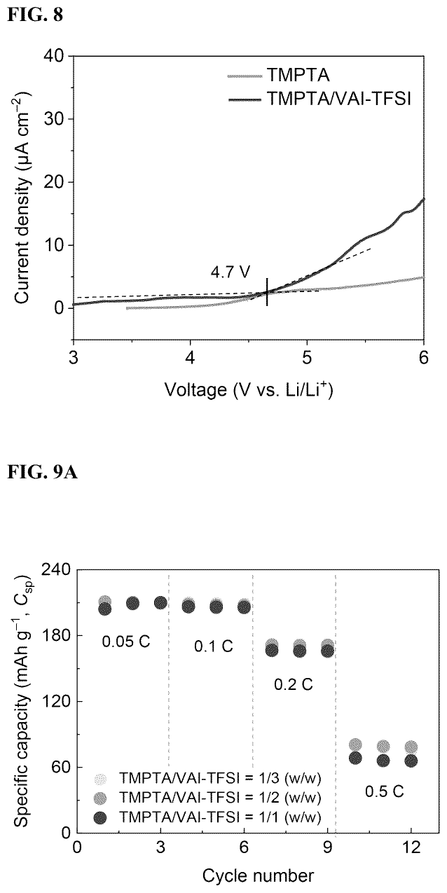

FIG. 8 illustrates the electrochemical stability window measured by linear sweep voltammetry (LSV) for TMPTA/VAI-TFSI and trimethylolpropane triacrylate (TMPT333999A) prepared in Example 1 of the present invention.

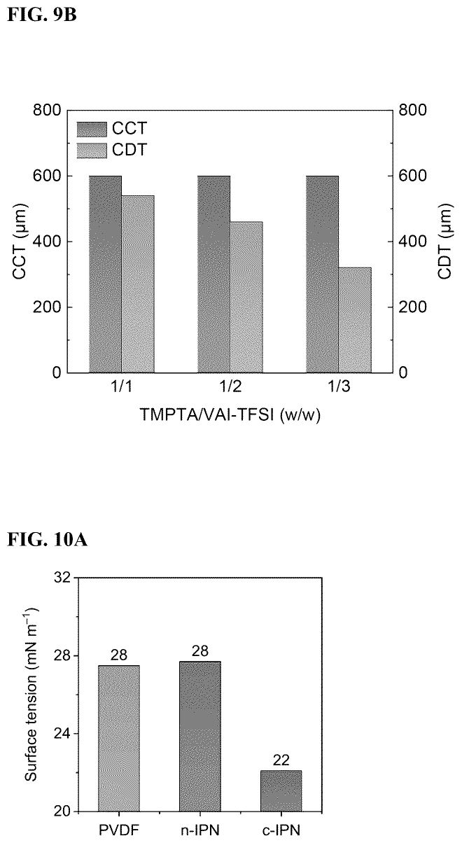

FIGS. 9A and 9B show the (A) discharge rate performance and (B) critical crack thickness (CCT) and critical delamination thickness (CDT) of the cathode (M/A=65 mg cm⁻²) using TMPTA/VAI-TFSI with varying composition ratios, as prepared in Example 1 of the present invention.

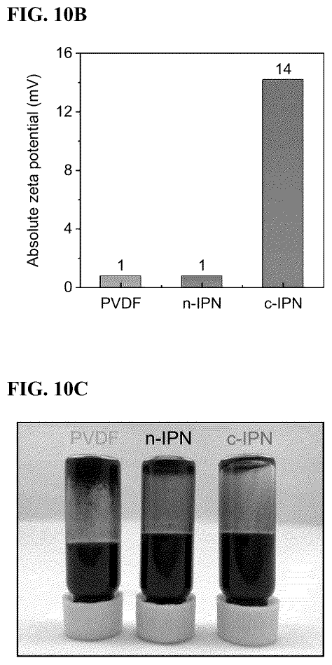

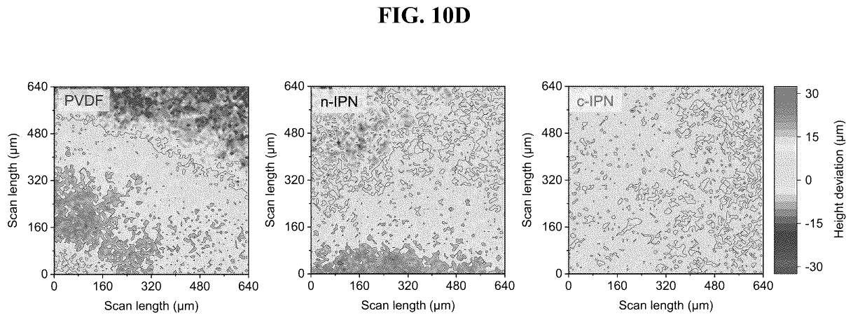

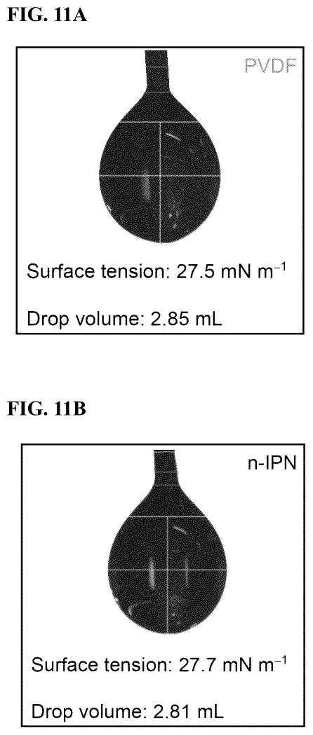

FIGS. 10A to 10D illustrate the following for the electrode slurry (30% solid content) prepared in Example 1 (c-IPN), Comparative Example 1 (n-IPN), and Comparative Example 2 (PVDF) of the present invention: (A) surface tension measured using the pendant drop method, (B) absolute zeta potential, (C) photographic images, and (D) laser scanning confocal microscopy (LSCM) surface topography images of electrodes prepared from the slurry with high M/A (=50 mg cm⁻²) in Example 1 (c-IPN), Comparative Example 1 (n-IPN), and Comparative Example 2 (PVDF).

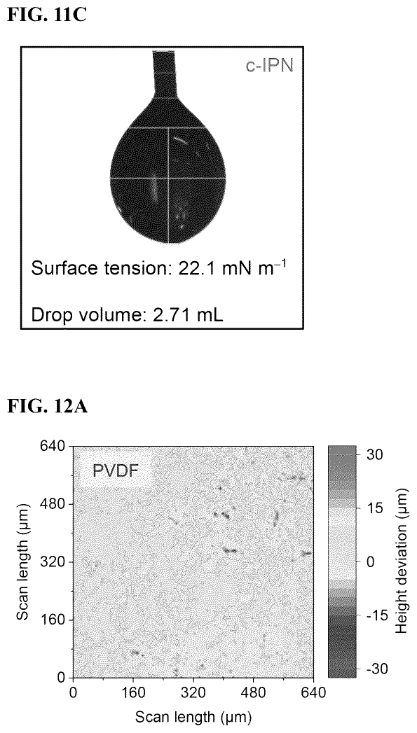

FIGS. 11A to 11C show photographs of the pendant drop tensiometer used to measure the surface tension of the electrode slurry prepared in Comparative Example 2 (PVDF) (A), Comparative Example 1 (n-IPN) (B), and Example 1 (c-IPN) (C) of the present invention.

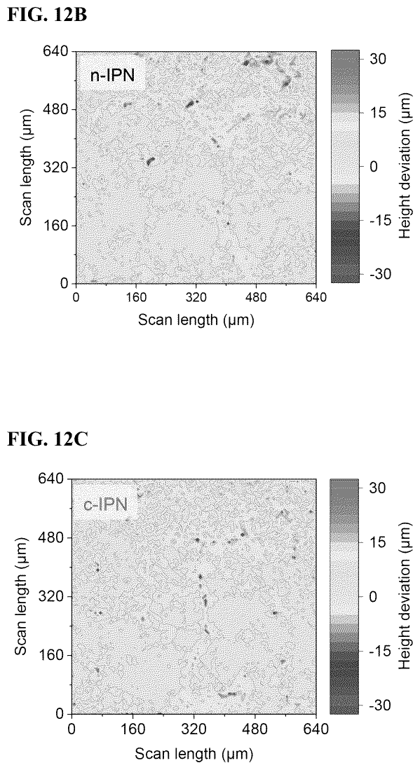

FIGS. 12A to 12C present the laser scanning confocal microscopy (LSCM) surface topography images of electrodes with low M/A (=26 mg cm⁻²) prepared in Comparative Example 2 (PVDF) (A), Comparative Example 1 (n-IPN) (B), and Example 1 (c-IPN) (C) of the present invention.

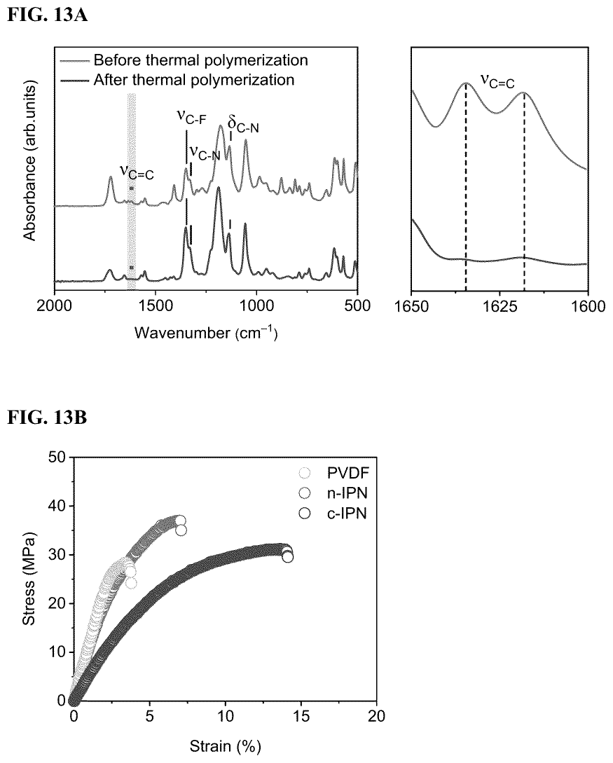

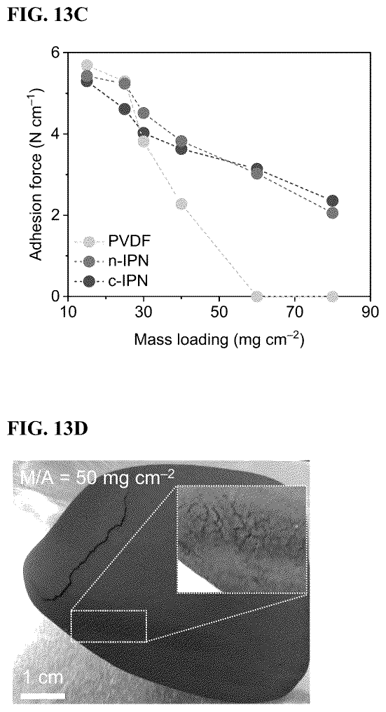

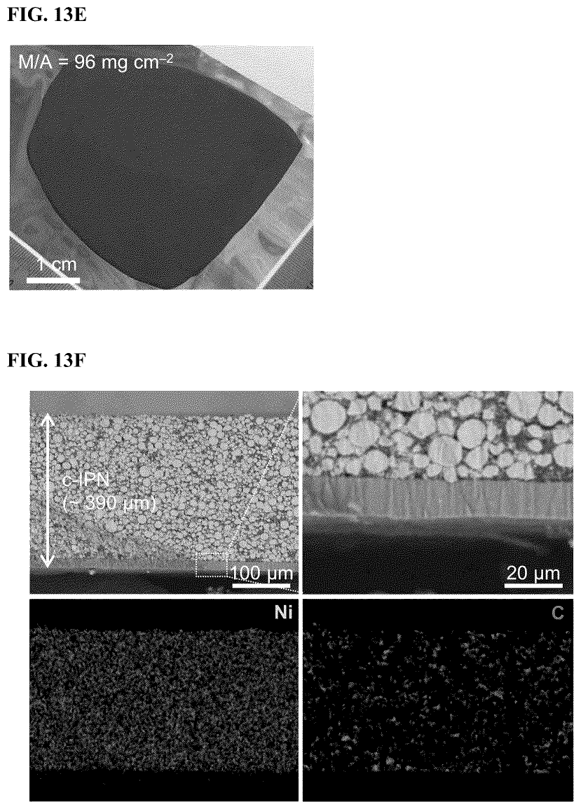

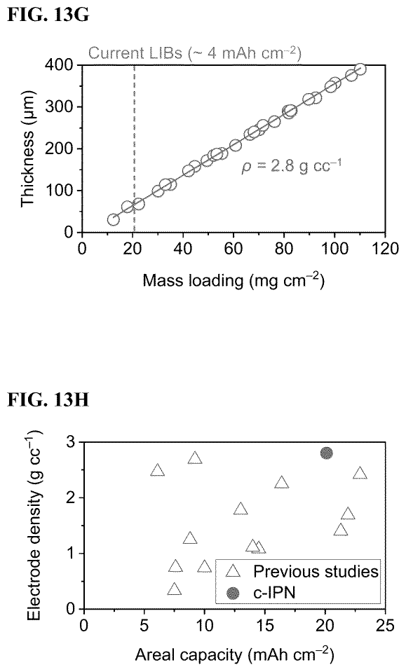

FIG. 13A to 13H illustrate the following:
(A) Fourier-transform infrared (FT-IR) spectra of c-IPN films before and after thermal crosslinking. (B) Stress-strain curves of PVDF, n-IPN, and c-IPN films. (C) Adhesion strength measured by 180° peel-off tests as a function of M/A for electrodes prepared in Comparative Example 1 (PVDF), Comparative Example 2 (n-IPN), and Example 1 (c-IPN) of the present invention. (D) A photographic image of the electrode (M/A=50 mg cm⁻²) prepared in Comparative Example 1 (PVDF). (E) A photographic image of the electrode (M/A=96 mg cm⁻²) prepared in Example 1 (c-IPN). (F) Cross-sectional scanning electron microscopy (SEM) and energy-dispersive X-ray spectroscopy (EDS) images of the electrode prepared in Example 1 (c-IPN) (M/A=96 mg cm⁻²). (G) Graph showing the thickness and electrode density (p) as a function of M/A for the electrode prepared in Example 1 (c-IPN) after roll pressing. (H) A graph comparing the electrode density as a function of C/A for the electrode prepared in Example 1 (c-IPN) with previously reported high M/A electrodes.

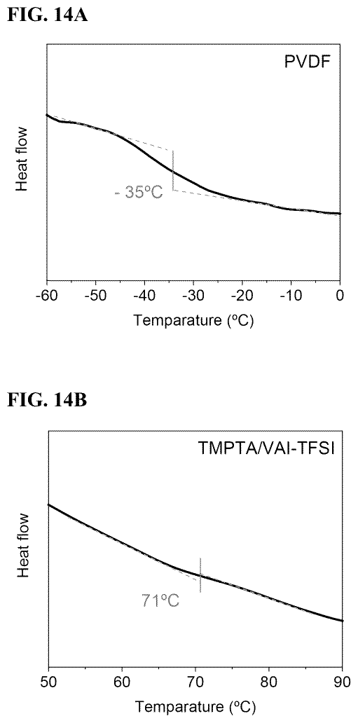

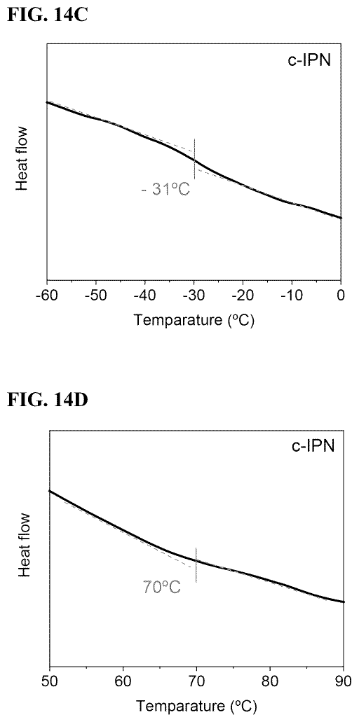

FIGS. 14A to 14D present differential scanning calorimetry (DSC) profiles showing the glass transition temperature (Tg) of (A) pristine PVDF film, (B) pristine TMPTA/VAI-TFSI crosslinked copolymer film, and (C, D) c-IPN films.

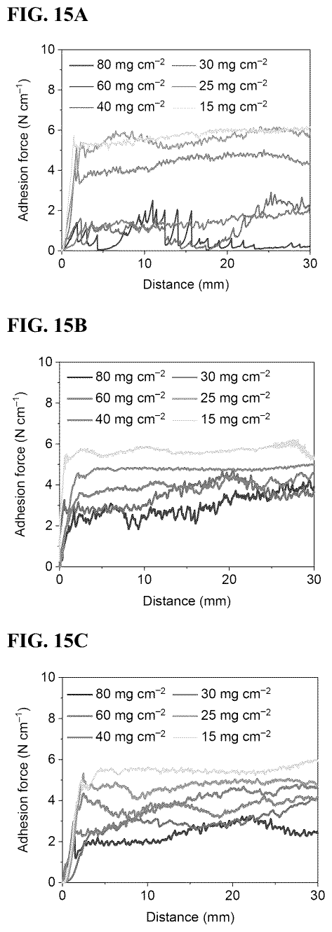

FIG. 15A to 15C illustrate the adhesion strength between the electrode active layer and the Al current collector for electrodes with various M/A values prepared using (A) PVDF, (B) n-IPN, and (C) c-IPN.

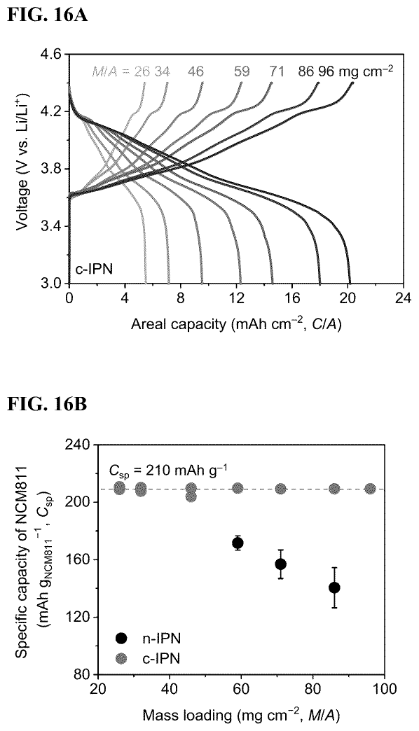

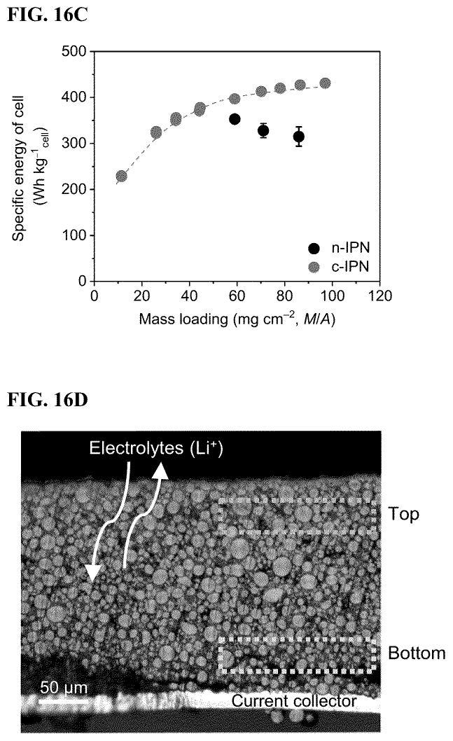

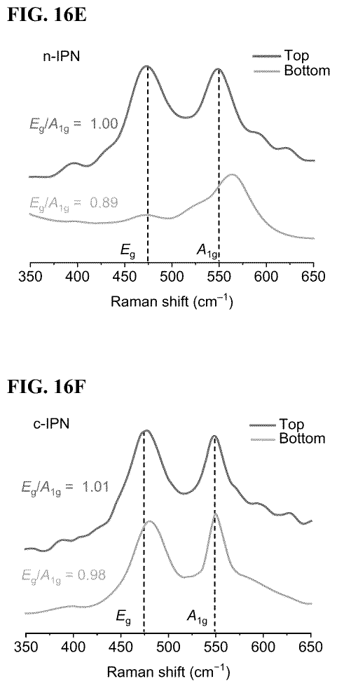

FIGS. 16A to 16F present the following:
(A) Constant current charge/discharge profiles at 25° C. as a function of cathode M/A for a cell using the cathode∥Li-metal anode prepared in Example 1 (c-IPN) of the present invention. (B) A graph showing the specific capacity (Csp) as a function of M/A at a 0.1 C discharge rate for cathodes prepared in Example 1 (c-IPN) and Comparative Example 1 (n-IPN). (C) A graph of specific energies as a function of M/A for cells using cathodes prepared in Example 1 (c-IPN) and Comparative Example 1 (n-IPN). (D) An optical microscopy image of the cross-section of the cathode obtained after disassembling a cell charged to 4.4 V at a current density of 1.1 mA cm⁻² using the cathode (M/A=65 mg cm⁻²) prepared in Example 1 (c-IPN). (E) Raman spectra and the intensity ratio of Eg/A1g for the top and bottom regions of the cathode prepared in Comparative Example 1 (n-IPN). (F) Raman spectra and the intensity ratio of Eg/A1g for the top and bottom regions of the cathode prepared in Example 1 (c-IPN).

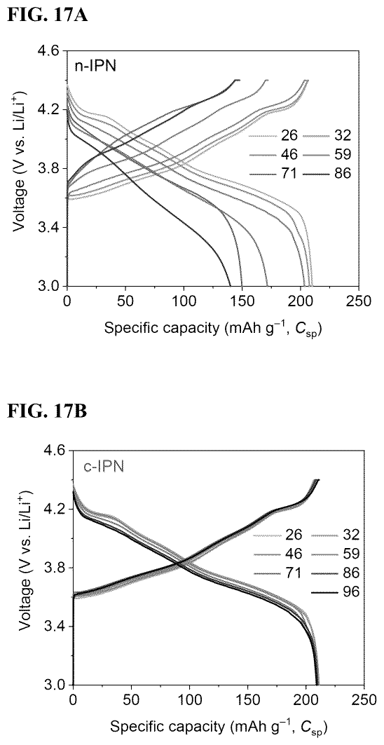

FIGS. 17A and 17B illustrate the constant current charge/discharge profiles as a function of cathode M/A (=26-96 mg cm⁻²) for cells combining Li-metal anodes with cathodes prepared in (A) Comparative Example 1 (n-IPN) and (B) Example 1 (c-IPN) of the present invention. The profiles were measured at charge/discharge current rates of 0.05 C/0.1 C within a voltage range of 3.0 to 4.4 V.

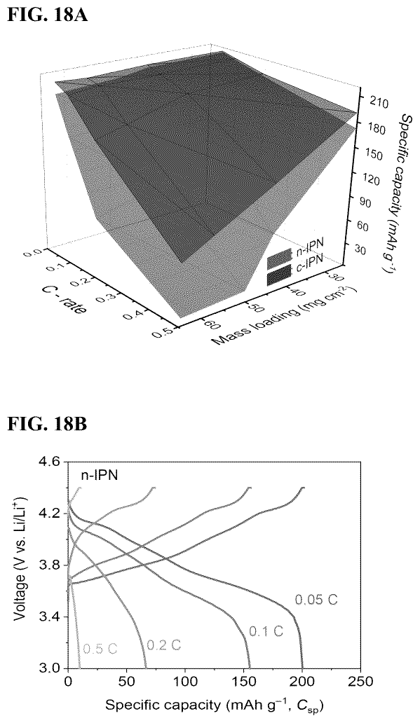

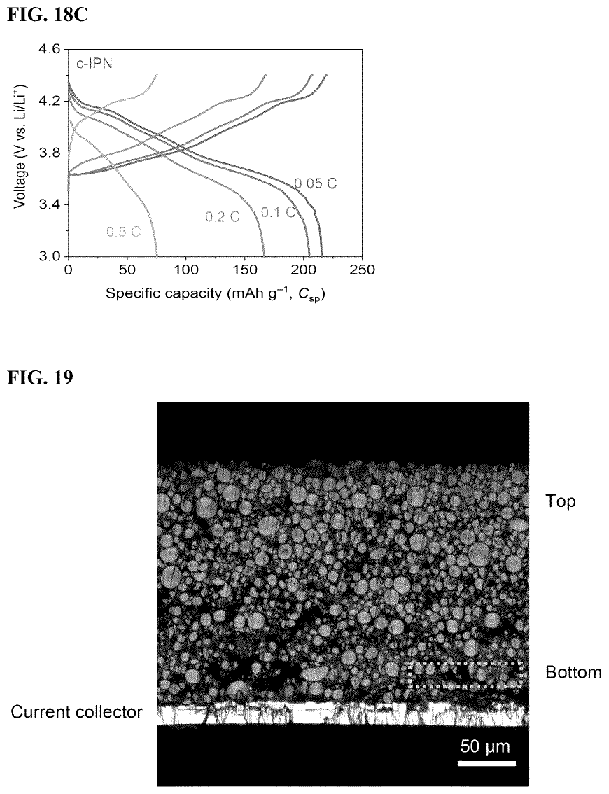

FIGS. 18A to 18C present the following:
(A) A graph showing the discharge rate performance (expressed as Csp) as a function of M/A for cells combining Li-metal anodes with cathodes prepared in Comparative Example 1 (n-IPN) and Example 1 (c-IPN) of the present invention. (B) The constant current charge/discharge profiles at discharge current rates of 0.05 C(=0.68 mA cm⁻²) to 0.5 C(=6.75 mA cm⁻²) for a cell using a cathode with high M/A (=65 mg cm⁻²) prepared in Comparative Example 1 (n-IPN). (C) The constant current charge/discharge profiles at discharge current rates of 0.05 C(=0.68 mA cm⁻²) to 0.5 C (=6.75 mA cm⁻²) for a cell using a cathode with high M/A (=65 mg cm⁻²) prepared in Example 1 (c-IPN).

FIG. 19 shows a cross-sectional optical microscopy image of the cathode (M/A=65 mg cm⁻²) prepared in Comparative Example 1 (n-IPN) of the present invention.

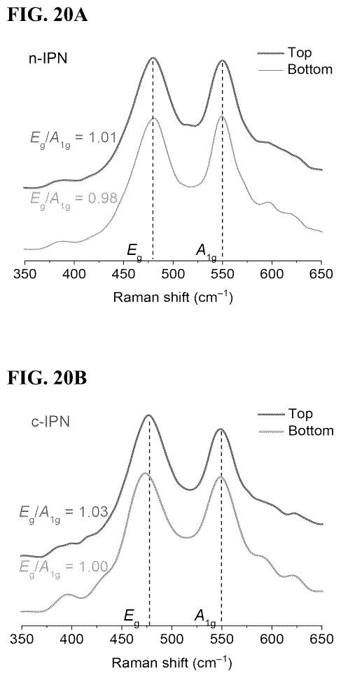

FIGS. 20A and 20B present the Raman spectra and intensity ratio (Eg/A1g) for the top and bottom regions of cathodes with low M/A (26 mg cm⁻²) after being charged at a current rate of 0.2 C(=1.1 mA cm⁻²). The cathodes were prepared in (A) Comparative Example 1 (n-IPN) and (B) Example 1 (c-IPN) of the present invention.

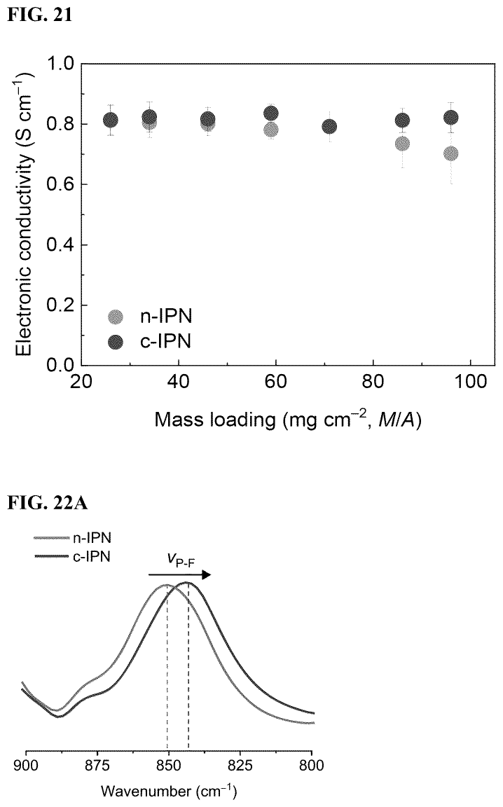

FIG. 21 illustrates the comparison of electrical conductivity (measured using a four-point probe station) as a function of M/A for cathodes prepared in Example 1 (c-IPN) and Comparative Example 1 (n-IPN) of the present invention.

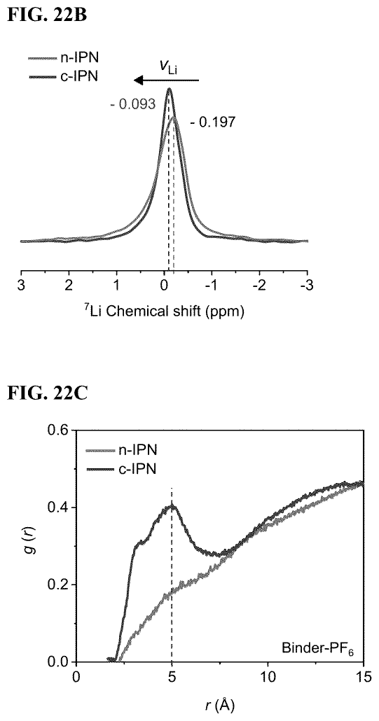

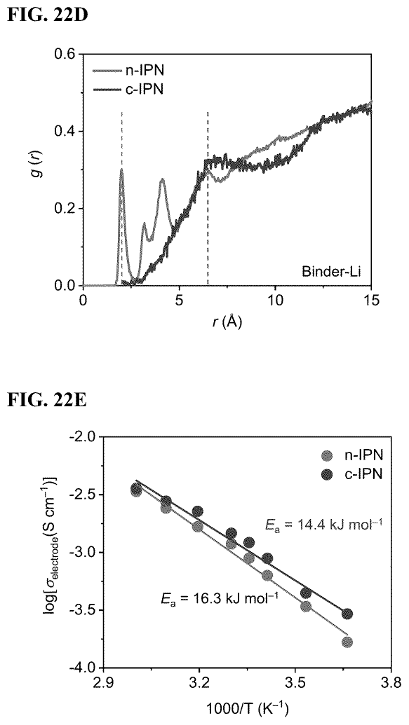

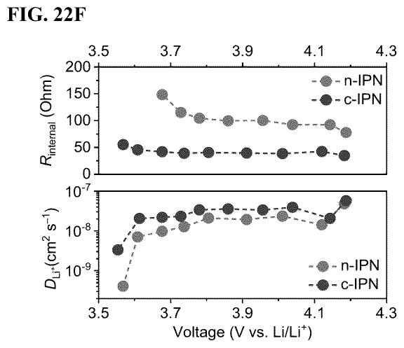

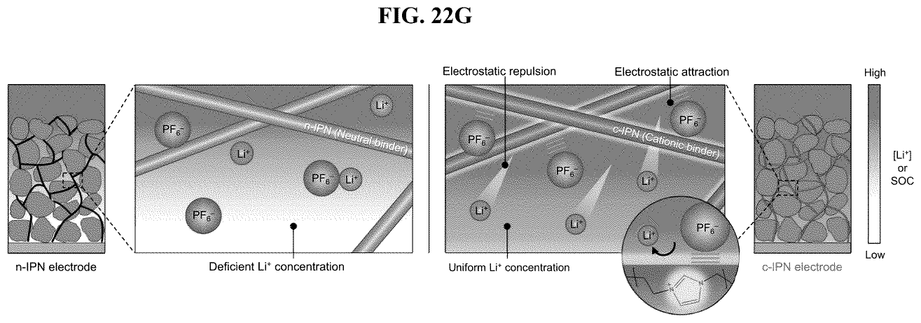

FIGS. 22A to 22G present the following:

(A) FT-IR spectra of cathodes prepared in Example 1 (c-IPN) and Comparative Example 1 (n-IPN) when in contact with a liquid electrolyte (1M LiPF₆ in EC/DEC=1/1 (v/v)). (B) ⁷Li magic angle spinning (MAS) nuclear magnetic resonance (NMR) spectroscopy results at the binder-electrolyte interface for cathodes prepared in Example 1 (c-IPN) and Comparative Example 1 (n-IPN). (C) Radial distribution function (RDF) profile of the P atom in PF₆⁻. (D) Radial distribution function (RDF) profile of the Li atom. (E) Arrhenius plot of ion conductivity in electrolyte-filled pores for cathodes (M/A=65 mg cm⁻²) prepared in Example 1 (c-IPN) and Comparative Example 1 (n-IPN). (F) Graph showing internal resistance (Rᵢₙₜₑᵣₙₐₗ) and D_{Li+} as a function of discharge voltage for cathodes (M/A=65 mg cm⁻²) prepared in Example 1 (c-IPN) and Comparative Example 1 (n-IPN). (G) A schematic diagram illustrating the role of the binder according to one embodiment of the present invention.

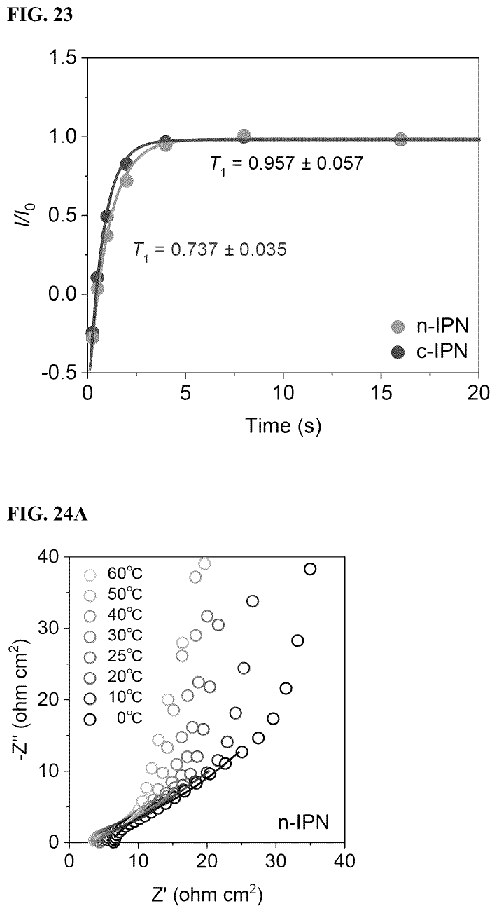

FIG. 23 presents the inversion-recovery plots obtained from the ⁷Li mAS NMR spectra of cathodes prepared in Example 1 (c-IPN) and Comparative Example 1 (n-IPN) of the present invention.

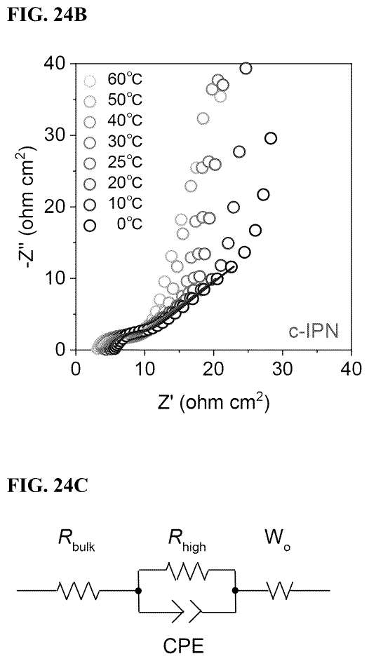

FIGS. 24A to 24C present the following:
(A) Nyquist plots for symmetrical cells (electrode∥electrode) containing fully lithiated cathodes with high M/A (=65 mg cm⁻²) prepared in Comparative Example 1 (n-IPN). (B) Nyquist plots for symmetrical cells (electrode∥electrode) containing fully lithiated cathodes with high M/A (=65 mg cm⁻²) prepared in Example 1 (c-IPN). (C) The equivalent circuit model using the generalized finite length Warburg element open circuit terminus (WO).

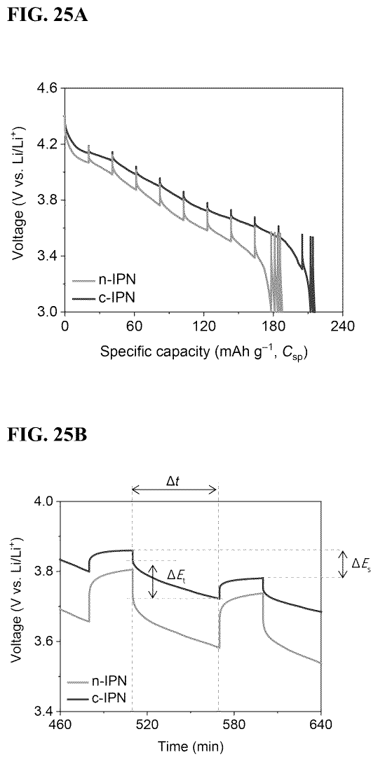

FIGS. 25A to 25B present the following for cathodes with high M/A (=65 mg cm⁻²) prepared in Comparative Example 1 (n-IPN) and Example 1 (c-IPN):
(A) The galvanostatic intermittent titration technique (GITT) profiles under repeated current pulses at a discharge current rate of 0.1 C(=1.35 mA cm⁻²). (B) The GITT profiles specifically highlighting the discharge phase.

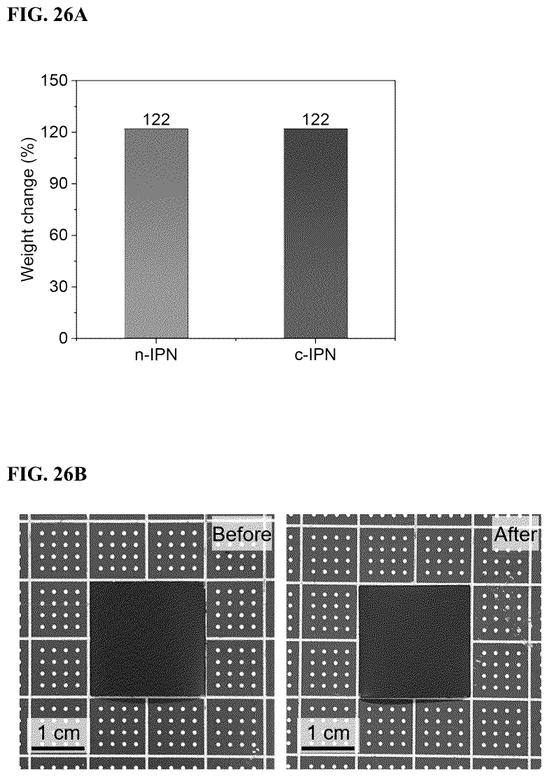

FIGS. 26A and 26B illustrate the following:
(A) The weight change of cathodes prepared in Comparative Example 1 (n-IPN) and Example 1 (c-IPN) after being immersed in a liquid electrolyte (1M LiPF₆ in EC/DEC=1/1 (v/v)) for 2 hours. (B) Photographic images of the cathode prepared in Example 1 (c-IPN) before (left) and after (right) electrolyte absorption.

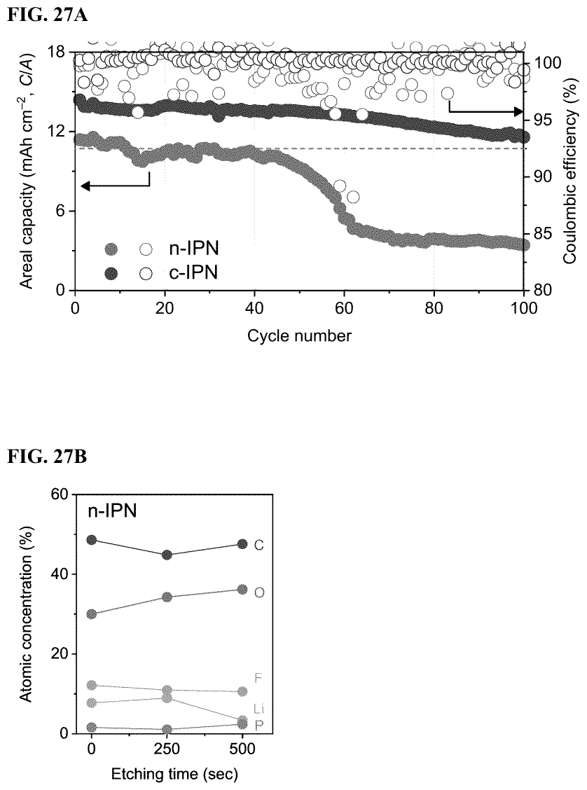

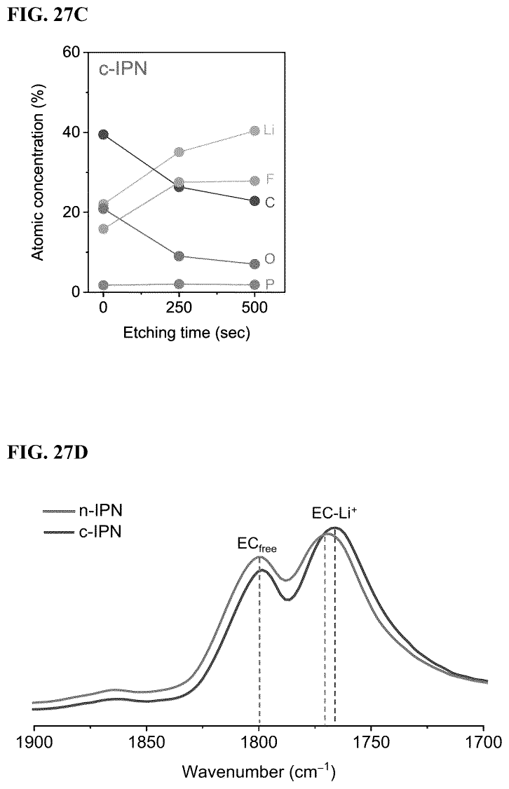

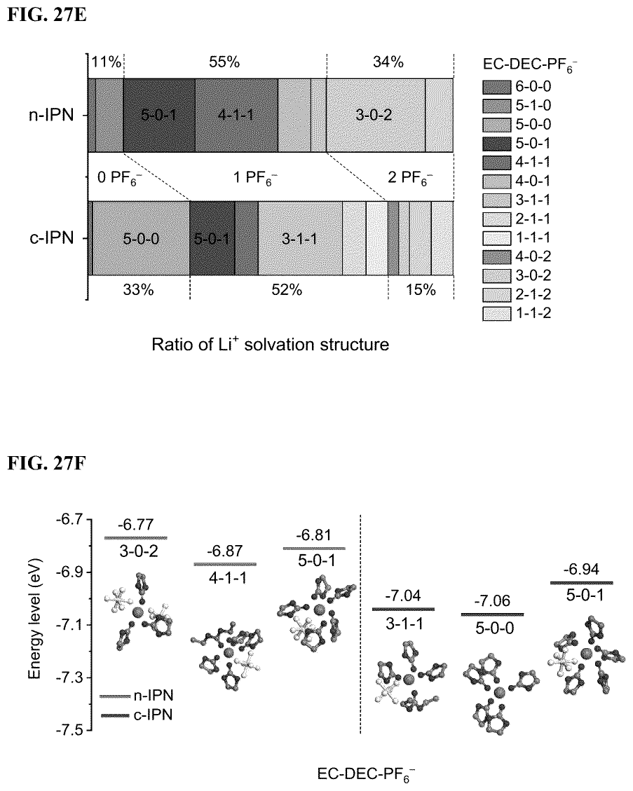

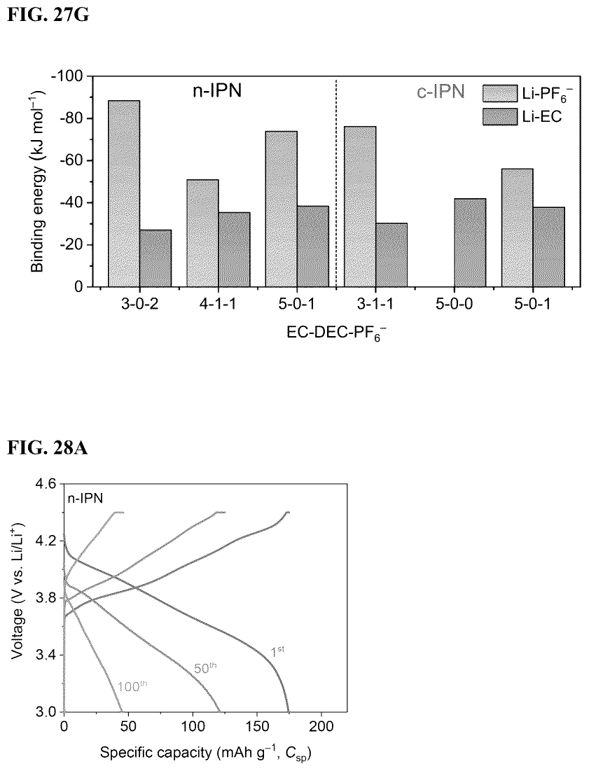

FIGS. 27A to 27G present the following:
(A) Cycling performance of Li-metal full cells using cathodes (M/A=65.0 mg cm⁻²) prepared in Comparative Example 1 (n-IPN) and Example 1 (c-IPN) of the present invention. (B) X-ray photoelectron spectroscopy (XPS) depth profiles of cycled cathodes prepared in Comparative Example 1 (n-IPN). (C) XPS depth profiles of cycled cathodes prepared in Example 1 (c-IPN). (D) FT-IR spectra of cathodes prepared in Comparative Example 1 (n-IPN) and Example 1 (c-IPN) in liquid electrolyte (1M LiPF₆ in EC/DEC=1/1 (v/v)), focusing on the carbonyl stretching vibration assigned to the EC solvent. (E) Graph showing the relative ratio of Lit solvation structures within the liquid electrolyte of cathodes prepared in Comparative Example 1 (n-IPN) and Example 1 (c-IPN). (F) HOMO (Highest Occupied Molecular Orbital) energy levels of the major Li⁺ solvation structures in cathodes prepared in Comparative Example 1 (n-IPN) and Example 1 (c-IPN). (G) Binding energies between the electrolyte components (PF₆⁻ and EC) and Li⁺ in cathodes prepared in Comparative Example 1 (n-IPN) and Example 1 (c-IPN).

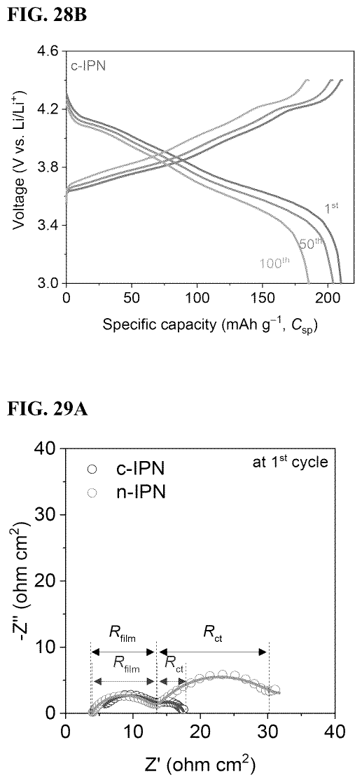

FIGS. 28A and 28B illustrate the constant current charge/discharge profiles at the 1st, 50th, and 100th cycles for Li-metal full cells using cathodes prepared in (A) Comparative Example 1 (n-IPN) and (B) Example 1 (c-IPN) of the present invention.

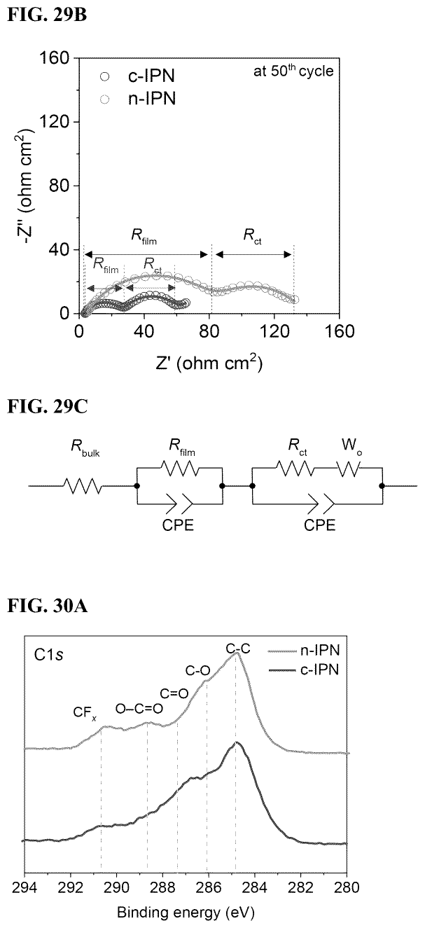

FIGS. 29A to 29C present the following:
(A) Nyquist plots from the 1st cycle of Li-metal full cells using cathodes prepared in Comparative Example 1 (n-IPN) and Example 1 (c-IPN) of the present invention. (B) Nyquist plots from the 50th cycle of the same cells. (C) The equivalent circuit used for fitting the Nyquist plots.

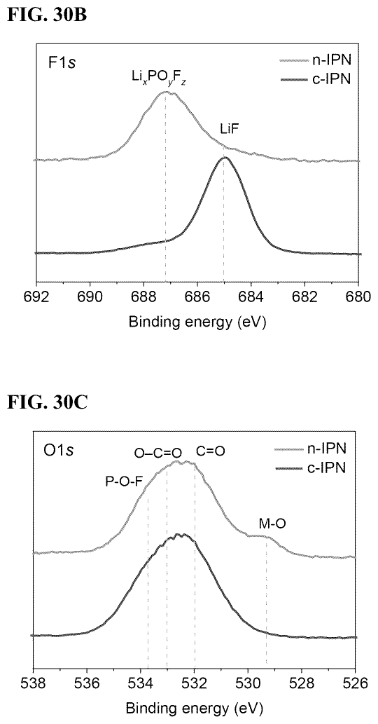

FIGS. 30A to 30C present the X-ray photoelectron spectroscopy (XPS) profiles for cycled NCM811 cathodes prepared in Comparative Example 1 (n-IPN) and Example 1 (c-IPN) of the present invention, showing the following:
(A) C1s profile, (B) F1s profile, and (C) O1s profile.

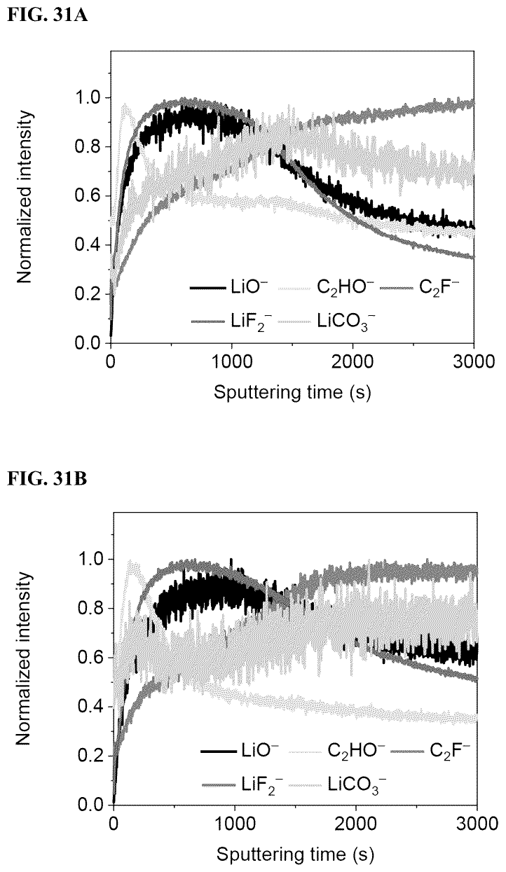

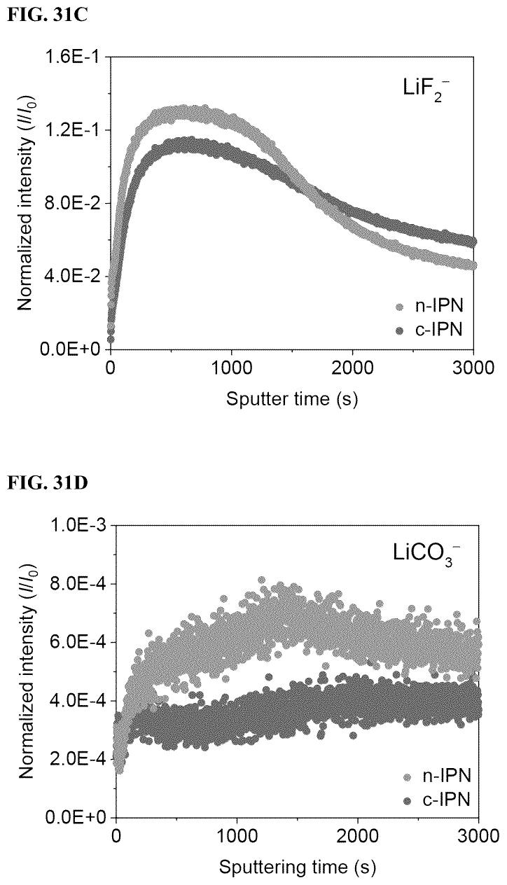

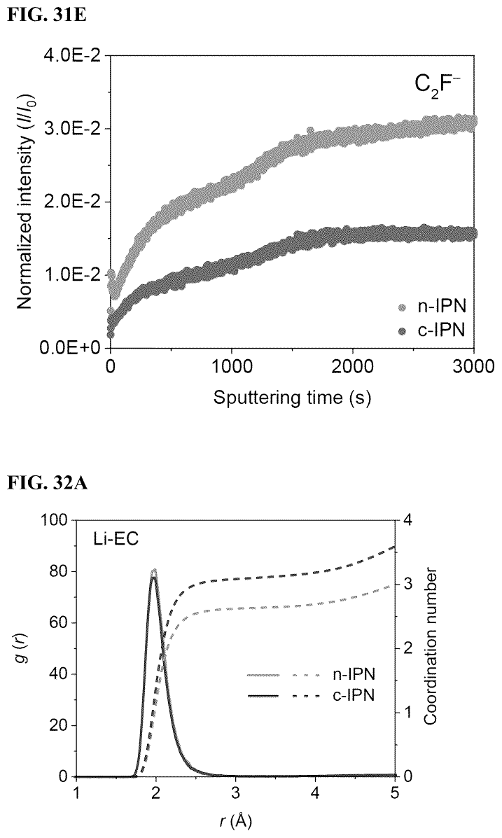

FIGS. 31A to 31E show the TOF-SIMS depth profiling of the cathodes after cycling in (A) Comparative Example 1 (n-IPN) and (B) Example 1 (c-IPN), as well as the TOF-SIMS depth profiles of (C) LiF₂⁻, (D) Li₂CO₃⁻, and (E) C₂F⁻.

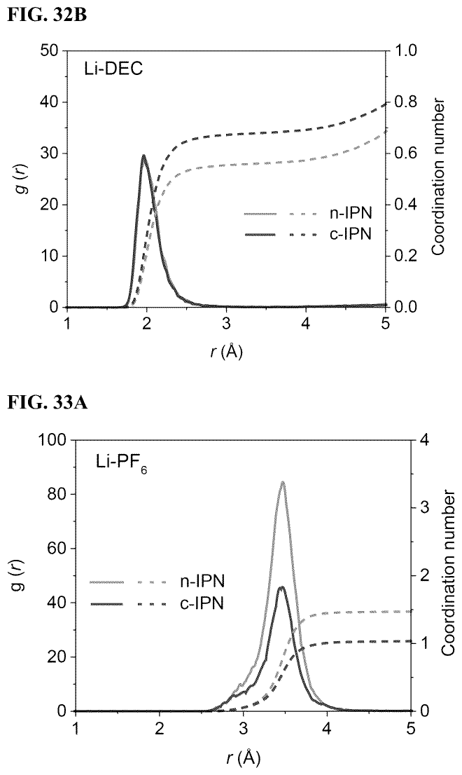

FIGS. 32A and 32B show the radial distribution function (RDF) profiles and coordination numbers (CN; between Li⁺ and solvent in the liquid electrolyte) at the binder-electrolyte (EC (A) and DEC (B)) interfaces of the cathodes manufactured in Comparative Example 1 (n-IPN) and Example 1 (c-IPN).

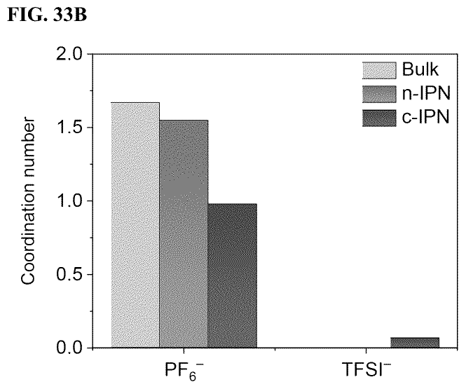

FIGS. 33A and 33B show the radial distribution function (RDF) profiles (A) and coordination numbers (CN) (B) between Li⁺ and PF₆⁻ in the liquid electrolyte at the binder-electrolyte interface and in the bulk electrolyte of the cathodes manufactured in Comparative Example 1 (n-IPN) and Example 1 (c-IPN).

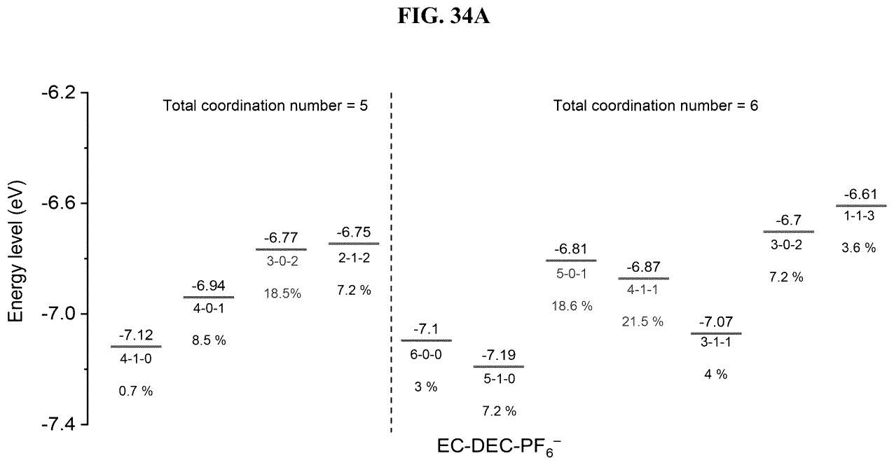

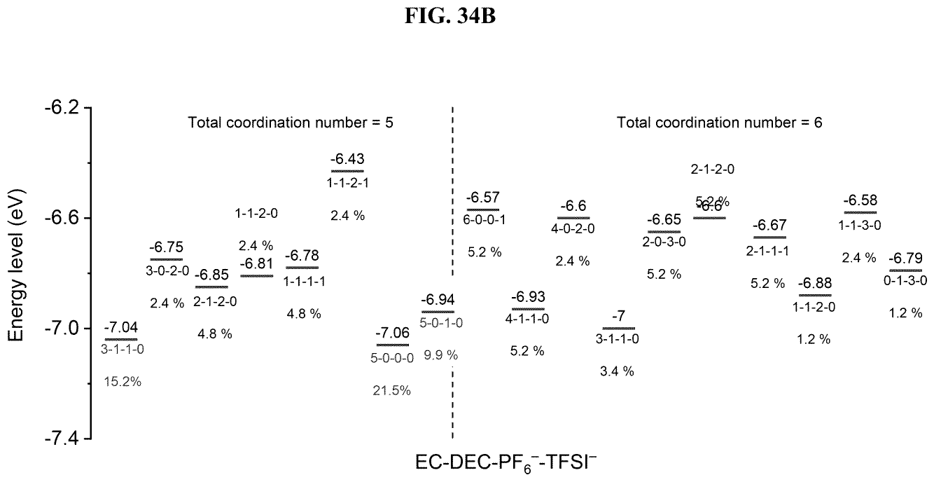

FIGS. 34A and 34B show the HOMO (highest occupied molecular orbital) energy levels and the relative ratios of Li⁺ solvation structures in the liquid electrolyte (EC/DEC with 1M LiPF₆=1/1 (v/v)) for the cathodes manufactured in Comparative Example 1 (n-IPN) (A) and Example 1 (c-IPN) (B).

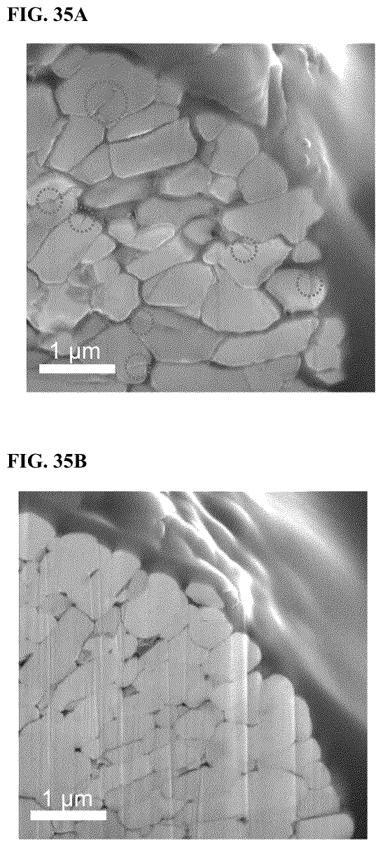

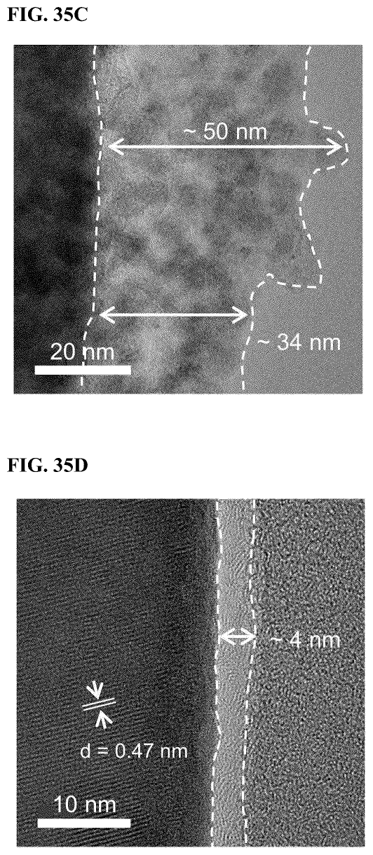

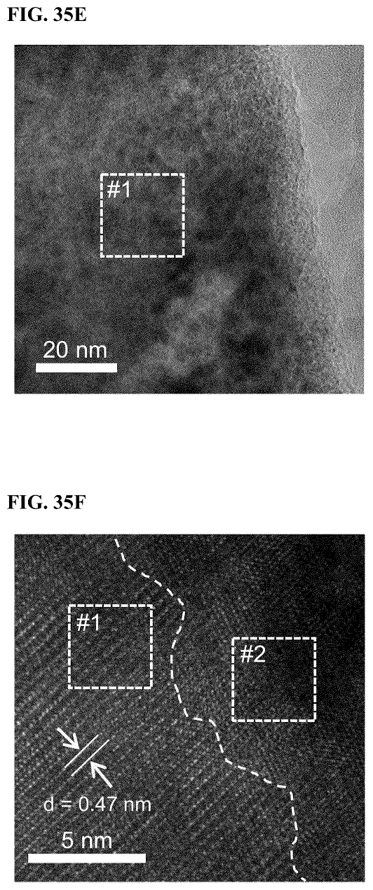

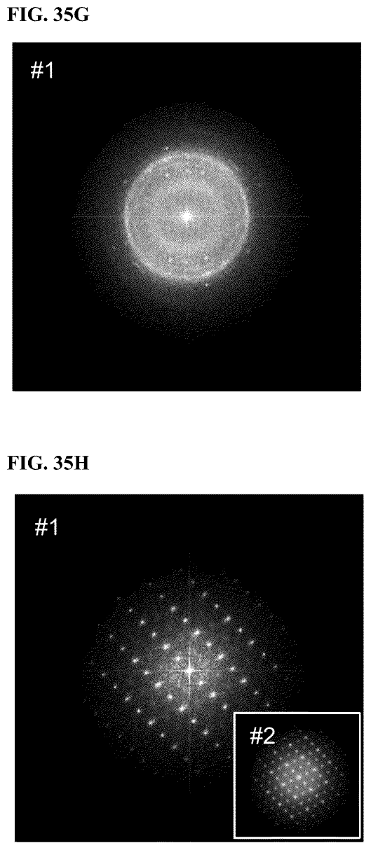

FIGS. 35A to 35H show the following for the cathodes manufactured in Comparative Example 1 (n-IPN) (A, C, E, G) and Example 1 (c-IPN) (B, D, F, H): cross-sectional scanning electron microscopy (SEM) images of cycled NCM811 (A, B), high-resolution transmission electron microscopy (HR-TEM) images (C—F), and fast Fourier transform (FFT) patterns (G, H).

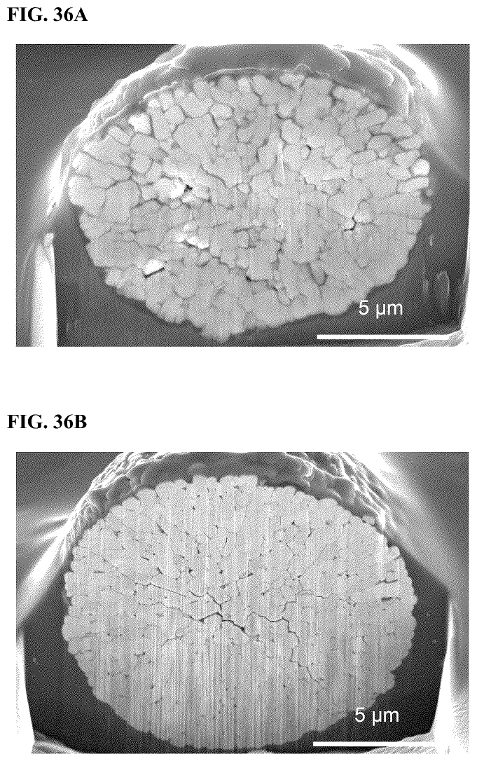

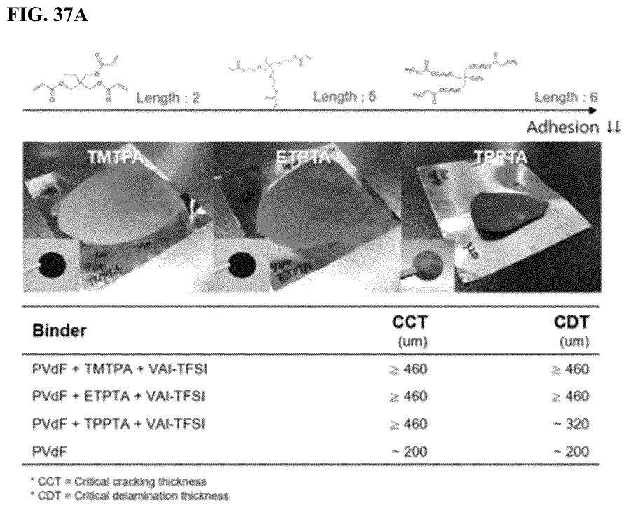

FIGS. 36A and 36B show cross-sectional scanning electron microscopy (SEM) images of cycled NCM811 particles in the cathodes manufactured in Comparative Example 1 (n-IPN) (A) and Example 1 (c-IPN) (B).

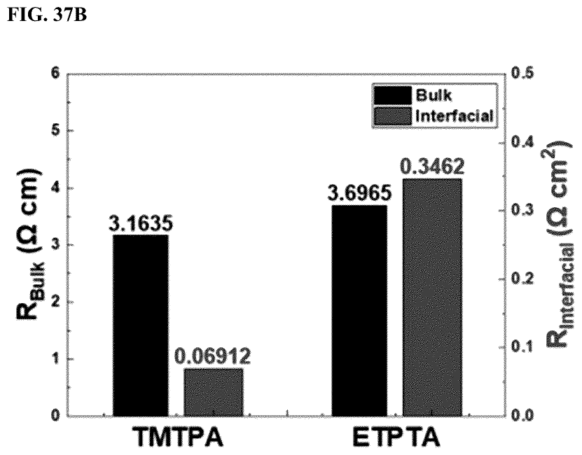

FIGS. 37A and 37B show the following:
(A) Photographic images of the cathodes manufactured in Comparative Example 1 (PVdF), Example 1 (TMPTA), Example 2 (TPPTA), and Example 3 (ETPTA), along with diagrams of the critical crack thickness (CCT) and critical delamination thickness (CDT).
(B) Graphs showing the bulk resistance (R_{Bulk}) and interfacial resistance (R_{Interfacial}) of the cathodes manufactured in Example 1 (TMPTA) and Example 3 (ETPTA).

The advantages and features of the present invention, and the methods for achieving them, will become clearer with reference to the detailed examples described below, along with the accompanying drawings. However, the invention is not limited to the embodiments disclosed herein; it may be implemented in various forms. These embodiments are provided to ensure that the disclosure of the invention is complete and to fully inform those skilled in the relevant technical field of the scope of the invention. The invention is defined solely by the claims.

In describing the present invention, detailed explanations of related prior art may be omitted if they are deemed to unnecessarily obscure the essence of the invention. When terms such as “comprises,” “includes,” or “is/are” are used in this specification, unless explicitly stated otherwise, it should be understood that other parts or elements may be added. Furthermore, the terms “comprise” or “include” are intended to specify the presence of features, numbers, steps, components, or their combinations as described in the specification, and should not be construed as excluding the presence or possibility of additional features, numbers, steps, components, or combinations thereof. Additionally, when a component is expressed in the singular, it should be understood to include the plural unless otherwise explicitly stated.

One aspect of the present invention is to provide a binder for secondary battery electrodes that includes a cationic semi-interpenetrating network polymer (semi-IPN).

The cationic semi-interpenetrating network polymer (semi-IPN) refers to a polymer in which a network polymer and a linear polymer are intermingled with each other.

FIG. 1 shows the following: 1. The chemical formula of the cationic semi-interpenetrating network polymer (c-IPN) according to one embodiment of the present invention. 2. A schematic diagram demonstrating the superiority of a cathode with a high area capacity (C/A) according to one embodiment of the present invention, compared to a control cathode with a lower area capacity (C/A) at the same cell capacity. 3. A schematic diagram illustrating the control of electrostatic phenomena by the binder according to one embodiment of the present invention.

As illustrated in FIG. 1, the binder for secondary battery electrodes according to the present invention, which includes the cationic semi-interpenetrating network polymer (c-IPN), enables the production of cathodes with high area capacity (C/A). It can interact with the liquid electrolyte to enhance the mobility of cations while fixing the corresponding anions. Additionally, the binder can uniformly distribute metal ions (Li+) within the electrode through electrostatic repulsion, while facilitating the free movement of these metal ions, thereby inducing an increase in ionic conductivity within the electrode and contributing to improved output and charging characteristics of the electrode.

The network polymer may be obtained by polymerizing a cationic monomer and a multifunctional crosslinking monomer.

The cationic monomer refers to a monomer that possesses a cationic group, and the network polymer will therefore include cationic groups within its main chain.

In the present invention, by using a network polymer polymerized from a cationic monomer, which is not a neutral monomer or polymer but one that possesses a cationic group, the cationic network polymer acts as a surfactant. This enhances the electrostatic repulsion with electrode components, alleviates internal stress due to solvent evaporation, and improves the dispersion state of the electrode slurry. Additionally, when combined with the mechanical toughness of the IPN structure, it helps suppress crack formation in the dried electrode, enabling the production of electrodes with a uniform topology and high M/A ratio.

The cationic group may be selected from the group consisting of imidazolium, pyridinium, phosphonium, sulfonium, pyrrolidinium, guanidinium, ammonium, isoauronium, thiouronium, piperidinium, pyrazolium, methylium, and morpholinium groups, with a preference for imidazolium, and more preferably, the 1-vinyl-3-allylimidazolium group.

In particular, imidazolium, pyridinium, pyrrolidinium, guanidinium, piperidinium, and pyrazolium groups are preferable due to their high oxidation stability, which allows for stable use in the anode. Moreover, the cationic groups exhibit decreasing cationicity in the order of imidazolium, pyridinium, ammonium, and phosphonium. Thus, when the cationic group is imidazolium, it can exhibit higher cationic properties, making it more preferable. Additionally, imidazolium groups not only provide high cationic properties but also offer dimensional stability that can increase by at least 1.2 times compared to other cationic groups, making them even more desirable.

When the cationic group includes an ammonium group, it can be represented as *—NRₐR_{b}—*, where Rₐ and R_{b} are each independently hydrogen or C1-C110 alkyl groups. Specifically, Rₐ and R_{b} are independently C1-C4 alkyl groups.

Additionally, the cationic group can fix the anions of the liquid electrolyte through electrostatic attraction while exhibiting electrostatic repulsion with metal ions (Li⁺). This enables the free movement and uniform distribution of metal ions (Li⁺) throughout the electrode, thereby establishing a stable cathode-electrolyte interface (CEI) in the electrode.

The cationic monomer may include a counterion for the cationic group, and this counterion can be selected from the group consisting of BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻ (TFSI⁻), N(COCF₃)(SO₂CF₃)⁻, N(SO₂F)₂⁻, N(CN)₂⁻, C(CN)₃⁻, SCN⁻, and SeCN⁻. Preferably, the counterion is N(SO₂CF₃)₂⁻ (TFSI⁻).

Most preferably, the cationic monomer is 1-vinyl-3-allylimidazolium bis(trifluoromethanesulfonyl)imide (VAI-TFSI).

The multifunctional crosslinking monomer refers to a monomer with at least two or more polymerizable functional groups.

If a simple polymerizable monomer with only one polymerizable functional group is used instead of a multifunctional crosslinking monomer, the resulting polymer will be linear rather than networked, even when polymerized with the cationic monomer. As a result, a cationic semi-interpenetrating network polymer (semi-IPN) will not be formed, leading to a significant reduction in toughness and causing noticeable breakage during the production of thin film electrodes.

The multifunctional crosslinking monomer may include one or more selected from the group consisting of acrylic, conjugated diene, alkene, diol, fatty acid, amino acid, hydroxy acid, ester, lactone, carbonate, cyclic ether, lactam, and their derivatives.

The polymerizable functional groups may be selected from the group consisting of acrylate, methacrylate, vinyl, and thiol groups, with acrylate groups being particularly preferred.

Specific examples of the crosslinkable monomer containing a polyfunctional group having two polymerizable functional groups may include ethylene glycol diacrylate (EGDMA), triethylene glycol diacrylate (TEGDA), polyethylene glycol diacrylate (PEGDA), and 1,6-hexanediol diacrylate (HDDA).

Specific examples of the crosslinkable monomer containing a polyfunctional group having three polymerizable functional groups may include ethoxylated trimethylolpropane triacrylate (ETPTA), trimethylolpropane propoxylate triacrylate (TPPTA), pentaerythritol triacrylate (PETA), and trimethylolpropane triacrylate (TMPTA), especially when there are three or more polymerizable functional groups, the linear polymer in the cationic semi-interpenetrating network polymer (semi-IPN) is firmly bound, and even after electrochemical cycling, loss of the linear polymer may not be observed at all.

The crosslinking monomer is preferably selected from the group consisting of pentaerythritol triacrylate (PETA) and trimethylolpropane triacrylate (TMPTA), with trimethylolpropane triacrylate (TMPTA) being particularly preferred.

When the crosslinking monomer is selected from the group consisting of pentaerythritol triacrylate (PETA) and trimethylolpropane triacrylate (TMPTA), it is preferable as it provides excellent modulus of the electrode, ensuring that the electrode does not deform during the electrode rolling process.

In contrast, when the multifunctional crosslinking monomer is trimethylolpropane propoxylate triacrylate (TPPTA) with a larger molecular weight, a reduction in the modulus of the electrode is observed, leading to more pronounced delamination of the electrode layer during rolling.

In particular, when the multifunctional crosslinking monomer is trimethylolpropane triacrylate (TMPTA), the binder used for secondary battery electrodes maintains its mechanical properties even after prolonged cycling under high-temperature conditions. This characteristic makes it especially preferable.

The network polymer may be obtained by polymerizing the cationic monomer and the multifunctional crosslinking monomer in a weight ratio of 0.8 to 7:1, preferably 1.2 to 5:1, more preferably 1.5 to 3:1, and most preferably 1.7 to 2.5:1.

When the cationic monomer is used in a more excessive amount so that the weight ratio is out of the above range, mechanical properties of the electrode may be rapidly degraded, and when the crosslinkable monomer containing the multifunctional group is used in an excessive amount, electrochemical performance may be degraded.

In particular, when the cationic monomer and the multifunctional crosslinking monomer are polymerized in a weight ratio of 1.2 to 5:1, with the cationic monomer being in excess, the electrode incorporating the binder for secondary battery electrodes shows a significant improvement in high-rate charge and discharge characteristics. This makes it particularly desirable.

The network polymer may be represented by the following chemical formula 1:

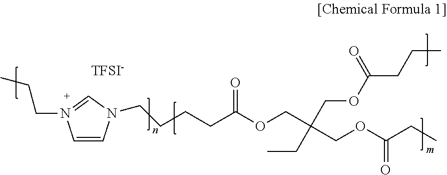

In Chemical Formula 1, n and m represent the degree of polymerization for each monomer unit, wherein n is an integer of 1 to 400, m is an integer of 1 to 200, and preferably n: m is 1:1 to 2:1.

In particular, the binder for a secondary battery electrode of the present invention includes the linear polymer, thereby enhancing the physical properties of the electrode, particularly its toughness, contributing to reduction of electrode cracking (fracture) during drying, and enabling physical manufacture of a thick electrode.

The linear polymer may be selected from the group consisting of cellulose-based polymers, acrylic polymers, and fluorine-containing polymers. Preferably, the linear polymer is a fluorine-containing polymer.

Specific examples of cellulose-based polymers include Carboxymethyl cellulose (CMC), Methyl cellulose (MC), Hydroxypropyl cellulose (HPC), Methyl hydroxypropyl cellulose (MHPC), Ethyl hydroxyethyl cellulose (EHEC), Methyl ethyl hydroxyethyl cellulose (MEHEC), Cellulose gum.

Specific examples of acrylic polymers include Polyacrylamide, Poly(methacrylic acid), Poly(methyl acrylate), Poly(methyl methacrylate), Poly(acrylic acid), Polyacrylonitrile.

In particular, when the linear polymer is a fluorine-containing polymer, it exhibits excellent chemical stability, especially oxidation stability. This results in a significant improvement in the reduction of impurity deposition due to side reactions at the cathode active material interface.

The fluorine-containing polymer may be at least one selected from the group consisting of polyvinylidene fluoride (PVdF), polytetrafluoroethylene (PTFE), a copolymer (PVdF-HFP) of polyvinylidene fluoride-hexafluoropropylene, and a copolymer (PVdF-TFE) of polyvinylidene fluoride-tetrafluoroethylene.

The linear polymer may be included in an amount of 45 to 100 parts by weight, preferably 50 to 90 parts by weight, and more preferably 55 to 70 parts by weight, based on 100 parts by weight of the network polymer.

If the linear polymer is used in less than 45 parts by weight relative to 100 parts by weight of the network polymer, the adhesive properties may be reduced. Conversely, if the linear polymer is used in more than 100 parts by weight relative to 100 parts by weight of the network polymer, the effectiveness of the network polymer may be diminished.

According to a preferred embodiment of the present invention, the network polymer is 1-vinyl-3-allylimidazolium bis(trifluoromethanesulfonyl)imide (VAI-TFSI), and the linear polymer is polyvinylidene fluoride (PVdF). When the electrode incorporating these components according to the preferred embodiment of the present invention is subjected to accelerated durability testing using conventional methods, it has been confirmed that neither the current collector nor the electrode active material coated on the current collector, nor the binder coating layer undergoes deformation, cracking, or wrinkling.

According to another preferred embodiment of the present invention, the network polymer is obtained by polymerizing the cationic monomer and the multifunctional crosslinking monomer in a weight ratio of 1.7 to 2.5:1, and the linear polymer may be included in an amount of 55 to 70 parts by weight relative to 100 parts by weight of the network polymer. It has been confirmed that, when satisfying all the specified weight ranges according to this preferred embodiment, the electrode exhibits particularly superior performance, with negligible heat generation due to short-circuiting in the safety evaluation for penetration, using conventional methods.

A polymerization initiator may be used for the polymerization.

The initiator may be a peroxide-based initiator selected from the group consisting of benzoyl peroxide (BPO), dicumyl peroxide, di-butyl peroxide, 2,5-dimethyl-2,5-di(t-butylperoxy) hexane, 2,5-dimethyl-2,5-di(t-butylperoxy)-3,3,5-trimethylcyclohexane, 3, 1,3-bis(t-butylperoxyisopropyl)benzene, n-butyl-4,4-bis(t-butylperoxy) valerate, p-chlorobenzoyl peroxide, 2,4-dichlorobenzoyl peroxide, and t-butylperbenzoate lauryl peroxide.

In a preferred embodiment of the present invention, the cationic monomers may include both \textcircled{1} (vinylbenzyl)trimethylammonium chloride and \textcircled{2} 1-methyl-1-(4-nitrobenzyl) piperidinium chloride. While specific experimental results are not explicitly stated in this specification, tests were conducted by varying the types and combinations of cationic monomers to manufacture electrodes. The cells made with these electrodes were heated to measure the temperature at which fire or explosion occurs. It was observed that when both \textcircled{1} (vinylbenzyl)trimethylammonium chloride and \textcircled{2} 1-methyl-1-(4-nitrobenzyl) piperidinium chloride were included, the onset temperature of fire or explosion was at least 20% higher than in cases where one or both of these monomers were absent. This indicates a significant increase in thermal stability.

In a preferred alternative embodiment of the present invention, the cationic monomers may include both \textcircled{1} 1-vinyl-3-allylimidazolium bis(trifluoromethanesulfonyl)imide (VAI-TFSI) and \textcircled{2} 1,3-bis(2,4,6-trimethylphenyl) imidazolium chloride. It was observed that when both \textcircled{1} VAI-TFSI and \textcircled{2} 1,3-bis(2,4,6-trimethylphenyl) imidazolium chloride were used, electrodes manufactured with these monomers could be wrapped around a stainless steel cylinder with a diameter of 1 mm and subjected to a bending test by wrapping and unwrapping the cylinder five times without any cracks or fractures occurring on the electrode surface. This indicates that the material exhibits excellent flexural strength.

In contrast, when either \textcircled{1} VAI-TFSI or \textcircled{2} 1,3-bis(2,4,6-trimethylphenyl) imidazolium chloride was absent, noticeable cracks and fractures appeared after only one wrapping and unwrapping cycle with a 1 mm diameter cylinder. Even when the cylinder diameter was increased to 5 mm, cracks and fractures were still observed, indicating poor flexibility.

The other aspect of the present invention is to provide an electrode that includes a binder for secondary battery electrodes.

In the electrode, based on the total weight of 100 parts by weight of the electrode, the binder for secondary battery electrodes can be included in an amount of 1 to 10 parts by weight, preferably 2 to 8 parts by weight, and more preferably 3 to 7 parts by weight.

In the electrode slurry, if the binder is less than the lower limit based on the total weight of 100 parts by weight of the slurry, the mechanical properties of the electrode may be weakened, potentially leading to detachment of the electrode active layer from the current collector or cracks in the electrode active layer. Conversely, if the binder exceeds the upper limit, it may result in a decrease in energy density and an increase in electrochemical resistance.

The electrode may have the binder for secondary battery electrodes and the electrode active material coated on the current collector.

The current collector may include one or more selected from the group consisting of aluminum (Al), copper (Cu), nickel (Ni), and carbon.

The electrode active material may be a conventional positive electrode active material. Non-limiting examples include lithium cobalt oxide (LiCoO₂), spinel-structured lithium manganese oxide (LiMn₂O₄), lithium manganese oxide (LiMnO₂), lithium nickel oxide (LiNiO₂), lithium iron phosphate (LiFePO₄), lithium manganese phosphate (LiMnPO₄), lithium cobalt phosphate (LiCoPO₄), lithium iron pyrophosphate (Li₂FeP₂O₇), lithium niobium oxide (LiNbO₂), lithium iron oxide (LiFeO₂), lithium magnesium oxide (LiMgO₂), lithium copper oxide (LiCuO₂), lithium zinc oxide (LiZnO₂), lithium molybdenum oxide (LiMoO₂), lithium tantalum oxide (LiTaO₂), lithium tungsten oxide (LiWO₂), layered lithium manganese nickel cobalt oxide (xLi₂MnO₃ (1−x)LiMn1−y−zNiyCozO₂), lithium nickel cobalt aluminum oxide (LiNi_{0.8}Co_{0.15}Al_{0.05}O₂), nickel manganese oxide (LiNi_{0.5}Mn_{1.5}O₄), and various lithium nickel cobalt manganese oxides (e.g., LiNi_{0.33}Co_{0.33}Mn_{0.33}O₂, LiNi_{0.4}Co_{0.2}Mn_{0.4}O₂, LiNi_{0.5}Co_{0.2}Mn_{0.3}O₂, LiNi_{0.6}Co_{0.2}Mn_{0.2}O₂, LiNi_{0.7}Co_{0.15}Mn_{0.15}O₂, LiNi_{0.8}Co_{0.1}Mn_{0.1}O₂), but the invention is not limited to these examples.

In particular, the electrode of the present invention may have the binder for secondary battery electrodes and the electrode active material mixed together. This approach differs from simply coating the binder onto a metal electrode or the electrode active material. By interacting electrostatically with the liquid electrolyte impregnated within the porous structure of the electrode, this method can increase the mobility of cations while fixing the corresponding anions.

The electrode may further include a conductive material.

The conductive material is not particularly limited as long as it is generally used in the art, but may be a carbon-based conductive material as a non-limiting example, and the carbon-based conductive material may include a point-type carbon-based conductive material, a linear carbon-based conductive material, a plate-type carbon-based conductive material, or a mixture thereof. Examples of the point-type carbon-based conductive material include acetylene black, Ketjen black, Channel black, Furnace black, lamp black, thermal black, and carbon black, and the like, and examples of the linear carbon-based conductive material may include carbon nanotubes, conductive carbon fibers, and the like, and examples of the plate-type carbon-based conductive material include graphene (including GRO).

When the electrode includes a conductive material, the cationic monomer interacts with the electrode active material and the conductive material in the electrode slurry. This interaction increases the repulsive forces between the electrode materials due to the high surface charge, thereby improving the distribution of materials within the electrode slurry.

The conductive material can be included in an amount of 1 to 7 parts by weight, based on the total weight of 100 parts by weight of the electrode, and preferably in an amount of 2 to 5 parts by weight.

If the amount of the conductive material is less than the lower limit based on the total weight of 100 parts by weight of the electrode, the electrical conductivity of the electrode may be reduced. Conversely, if the amount exceeds the upper limit, it may decrease the energy density.

Another aspect of the present invention is to provide a secondary battery that includes the electrode. The battery contains a cationic semi-interpenetrating network (semi-IPN) polymer within the electrode, which interacts with the liquid electrolyte impregnated in the porous structure. This interaction increases the mobility of cations while fixing the corresponding anions, thereby enhancing the ionic conductivity within the electrode and contributing to improved output and charging characteristics of the electrode.

The secondary battery may include one or more selected from the group consisting of lithium (Li), sodium (Na), zinc (Zn), and aluminum (Al).

Preferably, the secondary battery may be a lithium secondary battery.

Another aspect of the present invention is a device that includes the battery. The device can be selected from one of the following: a communication device, a transportation device, or an energy storage device.

Another aspect of the present invention provides a method for manufacturing a secondary battery electrode, which includes: (a) a step of preparing an electrode slurry by adding a binder and an electrode active material to a solvent; and (b) a step of obtaining the electrode by applying the electrode slurry. The binder used in the method includes a cationic monomer, a crosslinkable multifunctional monomer, and a linear polymer.

### (a) a Step of Preparing an Electrode Slurry by Adding a Binder and an Electrode Active Material to a Solvent

The step (a) is a stage where an electrode slurry is prepared by adding a binder and an electrode active material to a solvent.

The solvent may be one or more selected from the group consisting of dimethylformamide (DMF), methanol (MeOH), ethanol, propanol, isopropyl alcohol (IPA), tert-butyl alcohol (TBA), n-butane, methoxyethanol, ethoxyethanol, dimethylacetamide, dimethylformamide, and N-methyl-2-pyrrolidone (NMP). Preferably, the solvent is N-methyl-2-pyrrolidone (NMP).

The binder may include a cationic monomer, a crosslinkable multifunctional monomer, and a linear polymer.

The cationic monomer refers to a monomer that has a cationic group.

The cationic group may be selected from one or more of the following: imidazolium, pyridinium, phosphonium, sulfonium, piperidinium, guanidinium, ammonium, isouronium, thiouronium, piperidinium, pyrazolium, methylium, and morpholinium. Preferably, the cationic group is imidazolium, and more preferably, it is 1-vinyl-3-allylimidazolium.

The cationic monomer may include a counterion that is selected from one or more of the following: BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻ (TFSI⁻), N(COCF₃) (SO₂CF₃)⁻, N(SO₂F)₂⁻, N(CN)₂⁻, C(CN)₃⁻, SCN⁻, and SeCN⁻. Preferably, the counterion is N(SO₂CF₃)₂⁻ (TFSI⁻).

The crosslinkable multifunctional monomer refers to a monomer that has at least two polymerizable functional groups.

The crosslinkable multifunctional monomer may include one or more selected from the group consisting of acrylic-based, conjugated diene-based, alkene-based, diol-based, fatty acid-based, amino acid-based, hydroxy acid-based, ester-based, lactone-based, carbonate-based, cyclic ether-based, lactam-based monomers, and their derivatives.

The polymerizable functional groups may include one or more selected from the group consisting of acrylate groups, methacrylate groups, vinyl groups, and thiol groups. Preferably, the polymerizable functional group is an acrylate group.

Specific examples of crosslinkable multifunctional monomers with two polymerizable functional groups include ethylene glycol diacrylate (EGDMA), triethylene glycol diacrylate (TEGDA), polyethylene glycol diacrylate (PEGDA), and 1,6-hexanediol diacrylate (HDDA).

Specific examples of the crosslinkable monomer including a polyfunctional group having three polymerizable functional groups may include ethoxylated trimethylolpropane triacrylate (ETPTA), trimethylolpropane propoxylate triacrylate (TPPTA), pentaerythritol triacrylate (PETA), and trimethylolpropane triacrylate (TMPTA).

The network polymer may be obtained by polymerizing the cationic monomer and the crosslinkable multifunctional monomer in a weight ratio of 0.8 to 7:1, preferably 1.2 to 5:1, more preferably 1.5 to 3:1, and most preferably 1.7 to 2.5:1.

The network polymer may be represented by the following chemical formula 1:

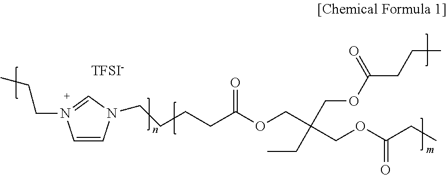

(In Chemical Formula 1, \(n \) and \(m \) represent the degree of polymerization of each monomer unit, where \(n \) is an integer ranging from 1 to 400 and \(m \) is an integer ranging from 1 to 200. Preferably, the ratio \(n:m \) is from 1:1 to 2:1.)

The linear polymer may include a fluorine-containing polymer.

The fluorine-containing polymer may be selected from one or more of the following: polyvinylidene fluoride (PVdF), polytetrafluoroethylene (PTFE), copolymers of polyvinylidene fluoride with hexafluoropropylene (PVdF-HFP), and copolymers of polyvinylidene fluoride with tetrafluoroethylene (PVdF-TFE).

The linear polymer can be included in an amount of 45 to 100 parts by weight, preferably 50 to 90 parts by weight, and more preferably 55 to 70 parts by weight, relative to 100 parts by weight of the crosslinked polymer.

The electrode active material can be any conventional cathode active material.

Non-limiting examples include lithium cobalt oxide (LiCoO₂), spinel-type lithium manganese oxide (LiMn₂O₄), lithium manganese oxide (LiMnO₂), lithium nickel oxide (LiNiO₂), lithium iron phosphate (LiFePO₄), lithium manganese phosphate (LiMnPO₄), lithium cobalt phosphate (LiCoPO₄), lithium iron pyrophosphate (Li₂FeP₂O₇), lithium niobium oxide (LiNbO₂), lithium iron oxide (LiFeO₂), lithium magnesium oxide (LiMgO₂), lithium copper oxide (LiCuO₂), lithium zinc oxide (LiZnO₂), lithium molybdenum oxide (LiMoO₂), lithium tantalum oxide (LiTaO₂), lithium tungsten oxide (LiWO₂), layered lithium manganese nickel cobalt oxide (xLi₂MnO₃ (1−x) LiMn1−y−zNiyCozO₂), lithium nickel cobalt aluminum oxide (LiNi_{0.8}Co_{0.15}Al_{0.05}O₂), nickel manganese oxide (LiNi_{0.5}Mn_{1.5}O₄), and lithium nickel cobalt manganese oxides (e.g., LiNi_{0.33}Co_{0.33}Mn_{0.33}O₂, LiNi_{0.4}Co_{0.2}Mn_{0.4}O₂, LiNi_{0.5}Co_{0.2}Mn_{0.3}O₂, LiNi_{0.6}Co_{0.2}Mn_{0.2}O₂, LiNi_{0.7}Co_{0.15}Mn_{0.15}O₂, LiNi_{0.8}Co_{0.1} Mn_{0.1}O₂). However, these examples are not limiting.

The electrode slurry may also include a conductive material.

The conductive material is not particularly limited as long as it is commonly used in the field. Non-limiting examples include carbon-based conductive materials. These carbon-based conductive materials may be in the form of spherical carbon-based conductive materials, linear carbon-based conductive materials, planar carbon-based conductive materials, or mixtures thereof.

Examples of spherical carbon-based conductive materials include acetylene black, ketjen black, channel black, furnace black, lamp black, thermal black, and carbon black. Examples of linear carbon-based conductive materials include carbon nanotubes and conductive carbon fibers. Examples of planar carbon-based conductive materials include graphene (including GRO).

The electrode slurry may also include a polymerization initiator that causes the cationic monomer and the multifunctional crosslinking monomer to polymerize and form a crosslinked polymer.

The initiator may be a peroxide-based initiator, including but not limited to benzoyl peroxide (BPO), dicumyl peroxide, di-butyl peroxide, 2,5-dimethyl-2,5-di-(t-butylperoxy) hexane, 2,5-dimethyl-2,5-di-(t-butylperoxy)-3,3,5-trimethylcyclohexane, 3, 1,3-bis(t-butylperoxyisopropyl)benzene, n-butyl-4,4-bis(t-butylperoxy) valerate, p-chlorobenzoyl peroxide, 2,4-dichlorobenzoyl peroxide, and t-butylperbenzoate lauryl peroxide.

### (b) The Step of Applying the Electrode Slurry to Obtain an Electrode

Step (b) is the step of applying the electrode slurry to obtain an electrode.

The application may be performed using one or more methods selected from the group consisting of doctor blade coating, roll coating, bar coating, slot die coating, comma coating, knife coating, gravure coating, micro-gravure coating, dip coating, flow coating, spin coating, and spray coating.

The application in step (b) may be performed by applying the electrode slurry onto a current collector.

The current collector may include one or more materials selected from the group consisting of aluminum (Al), copper (Cu), nickel (Ni), and carbon.

After step (b), the process may further include the step of heat-treating the applied electrode slurry.

The heat treatment may be performed at a temperature ranging from 25 to 120° C., preferably from 80 to 120° C.

If the heat treatment temperature is below the lower limit, the crosslinked polymer may not polymerize sufficiently. Conversely, if the temperature exceeds the upper limit, the rapid evaporation of the electrode slurry may cause delamination of the electrode layer.

During the heat treatment, the cationic monomer and the multifunctional crosslinking monomer can polymerize to form a crosslinked polymer. This results in the formation of a cationic semi-interpenetrating network polymer (semi-IPN) that has a structure in which the crosslinked polymer and the linear polymer are intermixed.

The following examples are provided to further illustrate the invention in detail. However, it should be noted that the scope and content of the invention are not to be construed as being limited or reduced by these examples.

### Example 1. Cationic Semi-Interpenetrating Polymer Network (c-IPN, TMPTA)

### Synthesis of 1-Vinyl-3-allylimidazolium bis(trifluoromethane sulfonyl)imide (VAI-TFSI)

As an intermediate of VAI-TFSI, 1-vinyl-3-allyl-imidazolium bromide (VAI-Br) was synthesized. 10.0 mmol of 1-vinylimidazole (Sigma-Aldrich) was mixed with 50 ml of acetonitrile (Sigma-Aldrich) and 12.0 mmol of allyl bromide (Sigma-Aldrich). Then, acetonitrile was removed with a rotary evaporator, and the resulting crude product was purified by decantation using 20 mL of ethyl acetate and 20 mL of diethyl ether, respectively, to synthesize 1-vinyl-3-allyl-imidazolium bromide (VAI-Br).

Dissolve 7.5 mmol of the synthesized 1-vinyl-3-allylimidazolium bromide (VAI-Br) in 50 mL of deionized water, and then add 7.5 mmol of lithium bis(trifluoromethane sulfonyl)imide (LiTFSI) to the solution. Extract the resulting mixture with 100 ml of dichloromethane. To remove any remaining organic impurities, further extract the solution with an additional 50 mL of deionized water for further purification. Purify the resulting dichloromethane layer using column chromatography with neutral alumina, and remove the dichloromethane using a rotary evaporator to obtain VAI-TFSI. The obtained VAI-TFSI is then dried overnight in a vacuum oven. The chemical structure of VAI-TFSI was confirmed using ¹H-NMR spectroscopy.

c-IPN Electrode Fabrication

A positive electrode slurry was prepared by dissolving LiNi_{0.8}Co_{0.1}Mn_{0.1}O₂ (NCM811, LG Energy Solution) and carbon black (Super C65) in N-Methyl-2-pyrrolidone (NMP, Aldrich) with a composition ratio of 92/3/5 (w/w/w). The binder used consisted of PVDF, a crosslinker trimethylolpropane triacrylate (TMPTA), and the previously prepared VAI-TFSI, with a weight ratio of 3 (60): 0.7 (13): 1.3 (27). Benzoyl peroxide (BPO, 1 wt %) was used as a thermal initiator. The mole ratio of VAI-TFSI to TMPTA was 1.6:1.

In the final electrode, a cationic semi-interpenetrating network (semi-IPN) polymer was formed, consisting of a network polymer created from the polymerization of VAI-TFSI and TMPTA, which was mixed with PVDF.

Next, the aforementioned electrode slurry was cast onto the Al current collector. After casting, the electrode slurry was dried at 100° C. for 1 hour, roll-pressed at 90° C., and then vacuum-dried at 120° C. for 12 hours before cell assembly. The electrode density of the finally manufactured electrode was set to 2.8 g/cc for a fair comparison. In the following experimental examples, the above electrode was used as the cathode.

### Example 2. TPPTA

The electrode was prepared in the same manner as in Example 1, except that trimethylolpropane propoxylate triacrylate (TPPTA) was used as the crosslinking agent instead of trimethylolpropane triacrylate (TMPTA).

### Example 3. ETPTA

The electrode was prepared in the same manner as in Example 1, except that ethoxylated trimethylolpropane triacrylate (ETPTA) was used as the crosslinking agent instead of trimethylolpropane triacrylate (TMPTA).

### Comparative Example 1. n-IPN

The electrode slurry and electrode were prepared in the same manner as in Example 1, except that polyvinylidene fluoride (PVDF, Solvay) was used as the binder and trimethylolpropane triacrylate (TMPTA) was used as the crosslinking agent in a weight ratio of 3:2.

### Comparative Example 2. PVDF

The electrode slurry and electrode were prepared in the same manner as in Example 1, except that only polyvinylidene fluoride (PVDF, Solvay) was used as the binder.

### Experimental Example. Setting Experimental Conditions Structural Characteristics

The electrochemical stability window of the crosslinked TMPTA and VAI-TFSI/TMPTA binders was investigated using linear sweep voltammetry (LSV) conducted with the working electrode (stainless steel) and the reference/counter electrode (Li-metal). The LSV measurements were performed at a scan rate of 1.0 mVs⁻¹.

The surface tension at the electrode slurry-gas interface was measured using a surface analyzer (Phoenix 300, SEO) with the pendant drop method. To ensure the reliability of the zeta potential measurement data (Zetasizer Nano ZS, Malvern), a model suspension was prepared at a diluted concentration (10 ppm) using NMP as the solvent. The model suspension was composed of a mixture of carbon conductive additive and binder in a ratio of 3:5 (w/w) in NMP, without the inclusion of NCM811 powder. This composition ratio of the model suspension was determined considering the cathode's composition ratio (NCM811/carbon black additive/binder=92/3/5 (w/w/w)).

The surface morphology and height deviation of the uncompressed electrode were characterized using a laser scanning confocal microscope (FV1000, Carl Zeiss). The height deviation was defined as the difference between the observed electrode height and the average height.

The thermal crosslinking reaction of the c-IPN and n-IPN electrodes was investigated using a Fourier transform infrared spectrometer (Alpha Platinum ATR, Bruker) with a spectral resolution of 4 cm⁻¹. The glass transition temperature (Tg) of the binder was estimated using a differential scanning calorimeter (Q2000, DuPont) with a heating rate of 20° C. min-1.

The tensile test of the binder film was conducted using a universal testing machine (DA-01, Petrol LAB) at a deformation rate of 0.5 mm min-1. The adhesion strength between the electrode and the Al current collector was measured using the same universal testing machine (DA-01, Petrol LAB) with a peel rate of 160 mm/min. For electrolyte swelling measurements, the electrode was immersed in a liquid electrolyte (1 M LiPF₆ in ethylene carbonate (EC)/diethyl carbonate (DEC) (1/1 (v/v))) at 25° C., and the weight change was recorded as a function of immersion time.

The cross-sectional morphology of the electrode was characterized using a field emission scanning electron microscope (S-4800, Hitachi) combined with an energy-dispersive X-ray spectrometer (JSM 6400, JEOL), with sample preparation carried out using an ion milling system (IM4000, HITACHI). The internal structure of the pouch cell was characterized using X-ray microtomography (Xradia 520 Versa, Carl Zeiss Inc.).

During tomography, 993 projection images were obtained using a 4× optical magnification. To analyze the microstructure of the cycled NCM811 particles, cross-sectional samples were thinned using a focused ion beam (Helios Nano Lab 450, FEI). The structural and chemical analysis of the thinned samples was performed using a high-resolution transmission electron microscope (HR-TEM, ARM300, JEOL).

### Electrochemical and Physicochemical Properties

The electronic conductivity of the electrode was measured using a four-point probe station (CMT-SR1000N, Advanced Instrument Tech). Electrochemical impedance spectroscopy (EIS) analysis of the symmetric cell (electrode∥electrode) was conducted in the fully lithiated state using a potentiostat/galvanostat (VSP classic, BioLogic) over a frequency range of 10⁻² to 10⁶ Hz with an applied amplitude of 10 mV.

The electrochemical performance of the electrode was characterized using 2032-type coin cells and pouch cells with the following configuration: NCM811 cathode∥polyethylene (PE) separator (thickness=16 μm)∥Li-metal anode (thickness=100 μm), and a liquid electrolyte consisting of 1 M LiPF₆ in EC/DEC=1/1 (v/v) containing 10 wt. % fluoroethylene carbonate (FEC) and 1 wt. % vinylene carbonate (VC). Unless otherwise specified, the electrolyte mass to cell capacity (E/C) ratio was 2.5 gA/h. A double-stacked pouch cell was fabricated using a c-IPN cathode (C/A 18 mAh cm⁻²)∥Li-metal anode (C/A 20 mAh cm⁻²), and the film was packaged in a dry room with a dew point of −50° C.

The electrochemical performance of the pouch cell was evaluated at 25° C. under a fixed pressure of 300 kPa. The specific energy and energy density of the coin cell were estimated based on the weight/volume of the cathode (including the Al current collector), anode (including the Cu current collector), separator, and electrolyte within the cell. Meanwhile, the specific energy and energy density of the pouch cell were estimated based on the experimentally measured weight/volume of the entire cell, including the pouch packaging film.

The detailed calculations for these energy densities are provided in Tables 1 and 2. Galvanostatic intermittent titration technique (GITT) analysis was conducted at a current density of 0.1 C(=1.35 mA cm⁻²) with a rest period of 30 minutes between each pulse. The electrochemical reaction kinetics of the electrode were investigated using cyclic voltammetry at a scan rate of 0.1 mV/s. The electrochemical performance of the cells was tested under various charge-discharge conditions using a cycle tester (PEBC050.1, PNESolution).

The degree of delithiation in the electrode along the thickness direction was confirmed using a Raman spectrometer (NRS-3100, JASCO). The oxidation state of the transition metal ions in the NCM811 particles was determined by estimating the intensity ratio of the Eg (bending mode along the metal-oxygen-metal a/b axis) and A1g (stretching mode along the metal-oxygen complex c-axis) modes. The structural evolution and electrostatic interactions between the electrode and anions (or solvents) were monitored using Fourier transform infrared spectroscopy (FTIR, Alpha Platinum ATR, Bruker).

The local environment of Li+ within the electrode was investigated using 7Li magic angle spinning (mAS) nuclear magnetic resonance (NMR) spectroscopy (600 MHZ FTNMR, VNMRS 600, Agilent) equipped with a 1.6 mm HXY Fast mAS T3 probe and a spinning rate of 20 KHz.

The 7Li chemical shifts were referenced to an external standard of 1.0 M aqueous LiCl solution at 0 ppm. For post-analysis, the cell was disassembled after 100 cycles in the discharged state, and residual salts were removed by rinsing with solvent (DMC) inside an Ar-filled glovebox. The samples for post-analysis were transferred using sealed pouches filled with inert gas.

The chemical changes on the surface of cycled NCM811 were analyzed using time-of-flight secondary ion mass spectrometry (TOF-SIMS 5, ION TOF) equipped with a Bi 2+ gun (25 keV, 1 pA) and X-ray photoelectron spectroscopy (XPS) using focused monochromatic Al Kα radiation (ESCALAB 250XI, ThermoFisher).

### Molecular Dynamics Simulation

All molecular dynamics (MD) simulations were performed using the materials Studio 2019 R2 (BIOVIA mAterials Studio) software. The COMPASSII force field was used to describe the interactions between LiPF₆, EC, DEC, VAI-TFSI, and TMTPA monomers. Van der Waals interactions were calculated using the atom-based cutoff method with a cutoff distance of 12.5 Å, while electrostatic interactions were handled using the Ewald summation method.

Temperature and pressure were controlled using the Nose-Hoover-Langevin (NHL) thermostat and the Berendsen barostat, with time coupling constants set to 1 ps and 0.1 ps, respectively. To investigate the solvation characteristics of Li+ near the c-IPN and n-IPN binder units, modeling of the bulk polymer system was performed. Ten monomers were prepared and equilibrated to describe the polymer binder chains. A detailed description of each model system is summarized in Table 7. The initial model systems were relaxed using steepest descent geometry optimization.

The convergence criteria for optimization were set to a maximum energy change of 0.001 kcal/mol and a maximum force of 0.5 kcal/mol·Å. Following optimization, a standard ensemble (i.e., NVT) simulation was performed at 298 K for 500 ps. In the second stage, an isothermal-isobaric ensemble (i.e., NPT) simulation was conducted at 298 K and 1 bar for 500 ps to achieve equilibrium. After equilibrating the bulk structure of the binder system, the cell was expanded, and each system was solvated with 1 M LiPF₆ in EC/DEC=1/1 (v/v) to describe the binder-electrolyte interface.

The equilibration of the solvated binder system was performed in three stages. First, the same geometry optimization as in the equilibration of the bulk polymer system was carried out. Second, an NVT simulation was conducted at 298 K for 500 ps. Finally, an NPT simulation was performed at 298 K and 1 atm for 4 ns. For the solvation analysis, the radial distribution function (RDF, (g_{αβ}(r)) was employed, which is described by the following equations (Equation 1 and Equation 2).

$${x}_{α} {x}_{β} ρ {g}_{αβ} ( r ) = \frac{1}{N} 〈 {\sum }_{i = 1}^{{N}_{α}} {\sum }_{j = 1}^{{N}_{β}} δ ( r - {r}_{i} - {r}_{j} ) 〉 \qquad [ Equation 1 ]$$

In Equation 1, xᵢ is the mole fraction of chemical species i, Nᵢ is the number of atoms (or molecules) of chemical species i or j, N is the total number of atoms, and p is the overall number density. The modified equation provides the coordination number (n_{αβ}(r)) derived from the equation.

$${n}_{αβ} ( r ) = 4 {πρ}_{β} {\int }_{{r}_{0}}^{{r}_{1}} {r}^{2} {g}_{αβ} ( r ) dr \qquad [ Equation 2 ]$$

In Equation 2, ρ_{β} represents the uniform number density of atom β, and the integration range between r₀ and r₁ corresponds to the first solvation shell. All analyses were performed on the last 1 ns of the NPT trajectory.

### Density Functional Theory Calculation

Density Functional Theory (DFT) calculations were performed using the DMol3 program to investigate the HOMO (Highest Occupied Molecular Orbital) energy levels of the Li⁺ solvation structure at the binder/electrolyte interface. The generalized gradient approximation (GGA) with the Perdew-Burke-Ernzerhof (PBE) exchange-correlation functional was employed, and core electrons were treated with relativistic effects for all-electron calculations. Grimme's method was applied for van der Waals (vdW) energy correction to account for vdW interactions.

Spin polarization was incorporated into all calculations. The molecular orbitals were expanded using the double numerical plus polarization (DNP) 4.4 basis set, with a global orbital cutoff set to 5.1 Å. The convergence criterion for consistent calculations was set to 1×10⁻⁶. The solvation environment of the Li solvation shell was described using the COSMO (Conductor-like Screening Model) method, applying a dielectric constant of ε=13.637. The dielectric constant (ε) of the solvation environment was calculated using the following equation 3, which accounts for the dielectric constant of the heterogeneous electrolyte mixture.

$$ε = {[ ( {ε}_{2}^{1 / 3} - {ε}_{1}^{1 / 3} ) {v}_{2} + {ε}_{1}^{1 / 3} ]}^{3} \qquad [ Equation 3 ]$$

In equation 3, εᵢ represents the dielectric constant of each electrolyte i (i.e., 89.78 for ethylene carbonate and 2.81 for diethyl carbonate), and v₂ denotes the volume fraction of the respective electrolyte.

### Experimental Example 1. Implementation of a High Energy Density Lithium Metal Full Cell was Confirmed Coil Cell

Using the cathode manufactured in Example 1 (c-IPN) with various C/A ratios and a 100 μm Li-metal anode (corresponding to 20 mAh cm⁻²), cells were assembled with the electrolyte mass/cell capacity (E/C) ratio set to 2.5 gA/h. The nominal voltage of the cell was estimated by integrating the discharge profile divided by the discharge capacity. The specific energy and energy density of the coin cells containing the c-IPN cathode were calculated according to equations 4 and 5, excluding packaging materials. The results are shown in FIG. 2A and Tables 1 and 2.

$$Specific energy ( Wh {kg}^{- 1} ) = \frac{Energy}{Mass of cell} = \frac{Nominal voltage \times C}{{M}_{cathode} + {M}_{anode} + {M}_{separator} + {M}_{electolyte}} \qquad [ Equation 4 ]$$

(In equation 4, M_{cathode}, M_{anode}, Mₛₑₚₑᵣₐₜₒᵣ, and M_{electrolyte} represent the masses of the cathode (including the Al current collector), anode (including the Cu current collector), separator, and injected electrolyte, respectively, while C denotes the discharge capacity.)

$$Energy density ( Wh {L}^{- 1} ) = \frac{Energy}{Volume of the cell} = \frac{Nominal voltage \times C / A}{{T}_{cathode} + {T}_{anode} + {T}_{separator}} \qquad [ Equation 5 ]$$

(In equation 5, T_{cathode}, T_{anode} and Tₛₑₚₑᵣₐₜₒᵣ represent the thicknesses of the cathode (including the 16 μm Al foil), anode (including the 9 μm Cu foil), and separator, respectively.)

TABLE 1

| | | | | | | | Specific |
|---|---|---|---|---|---|---|---|
| C/A | | | | | | | energy |
| (mAh | C | M_{cathode} | M_{anode} | Mₛₑₚₑᵣₐₜₒᵣ | M_{elctrolyte} | Mₜₒₜₐₗ | (Wh |
| cm⁻²) | (mAh) | (mg) | (mg) | (mg) | (mg) | (mg) | kg⁻¹) |
| 2.41 | 2.72 | 20.29 | 15.09 | 3.02 | 6.80 | 44.97 | 228 |
| 5.38 | 6.07 | 37.29 | 15.09 | 3.02 | 15.18 | 70.36 | 326 |
| 7.14 | 8.08 | 47.60 | 15.09 | 3.02 | 20.19 | 85.67 | 356 |
| 9.25 | 10.45 | 60.30 | 15.09 | 3.02 | 26.14 | 104.32 | 378 |
| 11.98 | 13.54 | 76.97 | 15.09 | 3.02 | 33.86 | 128.71 | 397 |
| 14.59 | 16.49 | 93.30 | 15.09 | 3.02 | 41.22 | 152.41 | 409 |
| 16.24 | 18.35 | 101.41 | 15.09 | 3.02 | 45.88 | 165.17 | 420 |
| 17.99 | 20.33 | 111.30 | 15.09 | 3.02 | 50.82 | 180.00 | 427 |
| 20.18 | 22.70 | 124.50 | 15.09 | 3.02 | 56.75 | 199.13 | 431 |

TABLE 2

| C/A | [symbol] | [symbol] | [symbol] | Energy density |
|---|---|---|---|---|
| (mAh cm⁻²) | (μm) | (μm) | (μm) | (Wh L⁻¹) |
| 2.41 | 61 | 109 | 16 | 4 [symbol] |
| 5.38 | 114 | 109 | 16 | 852 |
| 7.14 | 147 | 109 | 16 | 993 |
| 9.25 | 187 | 109 | 16 | 1122 |
| 11.98 | 24 [symbol] | 109 | 16 | 1242 |
| 14.5 [symbol] | 291 | 109 | 16 | 1327 |
| 16.24 | 318 | 109 | 16 | 1 [symbol] |
| 17.99 | 348 | 109 | 16 | 1438 |
| 20.18 | 39 [symbol] | 109 | 16 | 1482 |

[symbol]

indicates data missing or illegible when filed

FIG. 2A is a graph illustrating the specific energy and specific capacity of the active material (Cₛₚ) of the NCM811 battery as a function of the areal mass loading (M/A) of the cathode electrode, manufactured in Example 1 (c-IPN) of the present invention. The values presented exclude packaging materials.

As shown in FIG. 2A and Tables 1 and 2, the specific energy of the cell increased with the M/A, reaching a saturation level of approximately 427 Wh kg_{cell}⁻¹ (excluding packaging materials) at an M/A of 86 mg cm⁻². Additionally, the specific capacity (Csp) of NCM811 (˜210 mAh/g NCM811) was maintained over a wide range of M/A values, indicating that NCM811 can be effectively utilized even in thick c-IPN cathodes. Consequently, the cathode from Example 1 (c-IPN) provided a C/A of 20 mAh cm⁻², which is approximately five times higher than that of a commercial neutral linear polyvinylidene fluoride (PVDF) binder-based lithium-ion battery (LIB) cathode (˜4 mAh cm⁻²).

Meanwhile, a comparison of the C/A, Cₛₚ, Cₛₚ/theoretical Cₛₚ ratio, and specific energy (excluding packaging materials) between the electrode of the present invention and previously reported high C/A electrodes (primarily coin cell-based) is provided in Table 3 below.

TABLE 3

| | | C/A | [symbol] | Utilization | Specific energy |
|---|---|---|---|---|---|
| Reference | Type of cell | (mAh cm⁻²) | (mAh g⁻¹) | ( [symbol] theoretical [symbol] %) | (Wh kg⁻¹) |
| This study | Double-stacked | 20 | 210 | 100 | 431 |
| | pouch | | (NCM811) | | |
| 1 | Mono-stacked | 9 | 112 | 72 | 206 |
| | pouch | | (NCM111) | | |
| 2 | Mono-stacked | 6 | 158 | 93 | 246 |
| | pouch | | (NCM622) | | |
| 3 | Mano-stacked | 12 | 203 | 97 | 404 |
| | pouch | | (NCM811) | | |
| 4 | Coin | 8 | 128 | 88 | — |
| | | | (LCO) | | |
| 5 | Coin | 21 | 144 | 85 | — |
| | | | (LFP) | | |
| 6 | Coin | 2 | 150 | 88 | — |
| | | | (LFP) | | |
| 7 | Coin | 14 | 133 | 78 | — |
| | | | (LFP) | | |
| 8 | Coin | 7 | 140 | 82 | — |
| | | | (LFMP) | | |
| 9 | Coin | 9 | 130 | 86 | — |
| | | | (LFMP) | | |
| 10 | Coin | 14 | 142 | 97 | — |
| | | | (LCO) | | |
| 11 | Coin | 22 | 106 | 73 | 219 |
| | | | (LFP) | | |
| 12 | Coin | 7 | 126 | 74 | — |
| | | | (LFP) | | |
| 12 | Coin | 23 | 158 | 93 | — |
| | | | (LFP) | | |
| 13 | Coin | 28 | 132 | 91 | — |
| | | | (LCO) | | |
| 14 | Coin | 10 | 112 | 72 | 205 |
| | | | (NCM111) | | |
| 15 | Coin | 29 | 185 | 95 | 401 |
| | | | (NCM811) | | |
| 16 | Coin | 13 | 162 | 65 | — |
| | | | (OLO) | | |
| 17 | Coin | 16 | 152 | 89 | — |
| | | | (LFP) | | |
| 18 | Coin | 9 | 146 | 85 | — |
| | | | (LFP) | | |

[symbol]

indicates data missing or illegible when filed

As shown in Table 3, it can be confirmed that the electrode manufactured in Example 1 (c-IPN) demonstrates superior performance compared to conventionally reported electrodes.

### Double Laminated Pouch Type Full Cell

FIG. 2B is a photographic image of the double-stacked pouch cell using the electrode cathode (C/A=18 mAh cm⁻²) manufactured in Example 1 (c-IPN).

FIG. 3 is a photographic image of the double-stacked pouch-type full cell containing the electrode cathode (C/A=18 mAh cm⁻²) manufactured in Example 1 (c-IPN) of the present invention.

Since coin cells are insufficient to demonstrate the scalability of the electrode, as shown in FIGS. 2B and 3, a double-stacked pouch-type full cell was fabricated using the electrode cathode (C/A=18 mAh cm⁻²) manufactured in Example 1 (c-IPN). This cathode was combined with a Li-metal anode (20 mAh cm⁻², cathode vs. anode capacity ratio (N/P) of 1.1) under a limited amount of electrolyte (with an electrolyte mass/cell capacity (E/C) ratio of 2.5 gA/h for the carbonate-based liquid electrolyte). The double-stacked pouch cell had an area of 34×34 mm². The performance and characteristics of this cell were evaluated, and the results are presented in FIGS. 2C-D, 4, and 5.

FIG. 2C presents an X-ray microtomography image showing the cross-sectional structure of the double-stacked pouch cell that utilizes the electrode cathode (C/A=18 mAh cm⁻²) manufactured in Example 1 (c-IPN).

As shown in FIG. 2C, it was confirmed that the electrode cathode manufactured in Example 1 (c-IPN) is present with a thick (350 μm) thickness within the double-stacked pouch cell.

FIGS. 4A and 4B show the constant current charge/discharge profiles (A) and the corresponding dQ/dV plots (B) for the double-stacked pouch cell using the electrode cathode manufactured in Example 1 (c-IPN) at the 2nd, 40th, and 50th cycles. In FIGS. 4A and 4B, the current density was 0.9 mA cm^{-2/1.8} mA cm⁻², and the voltage range was 3.0-4.4 V. The cycled cathode was reassembled with a new lithium metal anode, separator, and liquid electrolyte at the 50th cycle.

As shown in FIGS. 4A and 4B, the fabricated cell produced a specific capacity (Csp) of 210 mAh g_{NCM811}⁻¹, indicating that it nearly fully utilized the theoretical Cₛₚ of NCM811.

FIG. 5 presents the comparison results of specific energy and energy density between the high-energy density pouch cell utilizing the electrode cathode manufactured in Example 1 (c-IPN) of the present invention and previously reported high-energy density pouch cells.

The values shown in FIG. 5 are the estimated specific energy and energy density based on the total mass and volume (including packaging materials) of the pouch cell. The cell parameters used for these estimations are provided in Table 4 below.

Table 4 provides detailed information for the calculation of specific energy and energy density for the double-stacked pouch-type full cell (including packaging materials). The areas of the cathode and anode in the cell were 34×34 mm² and 36×36 mm², respectively.

TABLE 4

| | Mass | M/A | C/A | Thickness |
|---|---|---|---|---|
| Cell components | (mg) | (mg cm⁻²) | (mAh cm⁻²) | (μm) |
| Cathode #1 | 1143 | 98.87 | 18.05 | 348 |
| Cathode #2 | 1139 | 98.52 | 17.99 | 347 |
| Anode | 266 | 20.55 | 20 (per single side) | 209 |
| Separator | 17 | — | — | 32 |
| Electrolyte | 1042 | — | — | — |
| Pouch packaging | 230 | — | — | 117 |

| Pouch parameter | *Stack | Total |
|---|---|---|
| Mass | 3607 | 4191 |
| (mg) | | |
| Thickness | 936 | 1166 |
| (μm) | | |

| | |
|---|---|
| Capacity | 416 |

(mAh)

| | |
|---|---|
| Energy | 1554 |

| | | |
|---|---|---|
| (mWh) | | |
| Specific energy | 437 | 376 |
| (Wh kg⁻¹) | | |
| Energy density | 1457 | 1043 |
| (Wh L⁻¹) | | |

*Stack represents core of the pouch cell excluding pouch packaging substances.

As shown in FIG. 5 and Table 4, the specific energy and energy density of the double-stacked pouch cell using the cathode manufactured in Example 1 (c-IPN) reached higher values than previously reported high-energy density pouch cells, specifically 376 Wh kg_{cell}⁻¹ and 1043 Wh L_{cell}⁻¹ (including packaging materials). This suggests that the present invention could further enhance cell energy density by introducing a multi-cell stack configuration, which would reduce the weight/volume contribution of packaging materials in the overall cell.

FIG. 2D shows the cycling performance of the double-stacked pouch cell using the electrode cathode (C/A=18 mAh cm⁻²) manufactured in Example 1 (c-IPN). The cycling was conducted at 25° C. with a charge/discharge current density of 0.9 mA cm^{-2/1.8} mA cm⁻² and within a voltage range of 3.0-4.4 V.

As shown in FIGS. 2D, 4A and 4B, the double-stacked pouch cell utilizing the electrode cathode (C/A=18 mAh cm⁻²) manufactured in Example 1 (c-IPN) demonstrated stable cycling retention even without the use of non-traditional electrolytes specifically designed for Li-metal anodes. Notably, after replacing the cycled Li-metal anode, liquid electrolyte, and separator with new ones, the cell nearly fully recovered its initial C/A, confirming that the c-IPN cathode was not the primary cause of cycling decay.

### Major Causes of Cycling Fading in Li-Metal Full Cells

To identify the main causes of cycling fading in the Li-metal full cell shown in FIG. 2D, three model cells were prepared as follows. The 0.05 C/0.1 C(=0.9 mA cm-2/1.8 mA cm⁻²) charge/discharge current rates and the constant current charge/discharge profiles cycled in the voltage range of 3.0-4.4 V for the reassembled pouch cells are presented in FIGS. 6A to 6C.
Model Cell #1: (Cycled Cathode with New Liquid Electrolyte∥New Li-Metal Anode)
Model Cell #2: (Cycled Cathode∥New Li-Metal Anode with Cycled Liquid Electrolyte)
Model Cell #3: (Cycled Cathode with New Liquid Electrolyte∥Cycled Li-Metal Anode).

FIGS. 6A to 6C shows the constant current charge/discharge profiles of (a) Cell #1 (Cycled Cathode∥New Li-Metal Anode with New Liquid Electrolyte), (b) Cell #2 (Cycled Cathode∥New Li-Metal Anode with Cycled Liquid Electrolyte), and (c) Cell #3 (Cycled Cathode with New Liquid Electrolyte∥Cycled Li-Metal Anode) in Experimental Example 1 of the present invention.

As shown in FIGS. 6A to 6C, Model Cells #1 and #2 returned to their initial voltage profiles with a high C/A value (˜18 mAh cm⁻²). However, Model Cell #3 did not return to its initial voltage profile, even with the new liquid electrolyte, and exhibited a rapid capacity fade during cycling. This indicates that replacing the cycled liquid electrolyte with a new one, while leaving the cycled Li-metal anode unchanged, failed to restore the initial voltage profile and resulted in rapid capacity degradation with continued cycling. On the other hand, replacing the cycled Li-metal anode with a new anode allowed the cell to return to a normal and stable voltage profile. This observation confirms that the cycled Li-metal anode is the main contributor to the cycling degradation in full cells utilizing a high C/A cathode.

### Experimental Example 2. Control of Electrostatic Phenomena on Dispersed State of c-IPN Cathode

FIG. 7 shows the ¹H Nuclear Magnetic Resonance (NMR) spectrum and chemical structure of 1-vinyl-3-allylimidazolium bis(trifluoromethanesulfonyl)imide (VAI-TFSI) synthesized in Example 1 of the present invention.

FIG. 8 shows the electrochemical stability window measured by linear sweep voltammetry (LSV) for TMPTA/VAI-TFSI and trimethylolpropane triacrylate (TMPTA) prepared in Example 1 of the present invention.

FIGS. 9A and 9B show (A) the discharge rate performance and (B) the critical crack thickness (CCT) and critical delamination thickness (CDT) of the cathode (M/A=65 mg cm⁻²) using TMPTA/VAI-TFSI with varying composition ratios, as prepared in Example 1 of the present invention. In FIG. 9, CCT refers to the critical electrode thickness at which cracks occur during electrode drying, while CDT refers to the critical electrode thickness at which the electrode layer delaminates from the Al current collector during roll pressing.

As shown in FIGS. 9A and 9B, the discharge rate performance of the electrode tended to increase with the increase in VAI-TFSI content. However, due to the poor binding strength of VAI-TFSI, the adhesion of the electrode slightly decreased. Consequently, it was determined that the optimal composition ratio of TMPTA/VAI-TFSI among the samples is ½ (w/w).

### Experimental Example 3: Control of Electrostatic Phenomena in the Dispersion State of c-IPN Cathode

Experiments were conducted to verify the effect of reducing surface tension in the electrode slurry, a phenomenon known to mitigate internal stresses arising from drying and thus prevent electrode cracking issues. The results are presented in FIGS. 10A to 10D and 11A to 11C.

FIGS. 10A to 10D show the following for electrode slurries (with a 30% solid content) prepared in Example 1 (c-IPN), Comparative Example 1 (n-IPN), and Comparative Example 2 (PVDF): (A) Surface tension measured using the pendant drop method, (B) Absolute zeta potential, (C) Photographic images, and (D) Laser Scanning Confocal Microscopy (LSCM) surface topography images of electrodes (M/A=50 mg cm-2) prepared using the slurries from Example 1 (c-IPN), Comparative Example 1 (n-IPN), and Comparative Example 2 (PVDF).

FIGS. 11A to 11C show photographs of the pendant drop tensiometer used to measure the surface tension of electrode slurries prepared in (A) Comparative Example 2 (PVDF), (B) Comparative Example 1 (n-IPN), and (C) Example 1 (c-IPN) of the present invention.

As shown in FIGS. 10A and 11A to 11C, the electrode slurry in Example 1 (c-IPN) exhibited lower surface tension compared to the electrode slurries in the comparative examples. This is because the c-IPN binder acts as an ionic surfactant.

As shown in FIG. 10B, the zeta potential analysis was performed on a model suspension (carbon conductive additive/binder=⅗ (w/w) in NMP solvent) prepared at a low concentration of 10 ppm. The results showed that the electrode slurry in Example 1 (c-IPN) exhibited a much higher absolute zeta potential value (˜14 mV) compared to the comparative example containing a neutral binder (˜1 mV), confirming the cationic nature of the c-IPN binder.

As shown in FIG. 10C, the electrode slurry in Example 1 (c-IPN) exhibited a well-dispersed state, whereas some particle agglomerates were observed in the electrode slurry of the comparative examples. This corresponds with previously reported findings that a high absolute zeta potential value in a suspension solution helps improve the dispersion state.

To examine how the state of the electrode slurry affects the dispersion uniformity in the dried electrode, laser scanning confocal microscopy (LSCM) analysis was conducted to map the surface roughness. The findings are illustrated in FIGS. 12A to 12C.

FIGS. 12A to 12C show Laser Scanning Confocal Microscopy (LSCM) surface topography images of electrodes with a low M/A (=26 mg cm⁻²) prepared in (a) Comparative Example 2 (PVDF), (b) Comparative Example 1 (n-IPN), and (c) Example 1 (c-IPN) of the present invention.

As shown in FIGS. 12A to 12C, at a low M/A (e.g., 26 mg cm⁻²), all electrodes exhibited uniform topography. However, as shown in FIG. 10D, when the M/A increased to 50 mg cm⁻² the electrodes in the comparative examples showed significant deviations due to the non-uniform dispersion of electrode components. These height variations can cause uneven pressure distribution across the electrode during roll pressing, potentially leading to dimensional instability and non-uniformity in the electrode.wjs. In contrast, the height deviations in the electrode from Example 1 (c-IPN) were negligible across a wide scanning area, owing to the well-dispersed slurry state. This result confirms the feasible role of the c-IPN binder in controlling electrostatic phenomena during slurry casting, which is critical for the fabrication of high M/A electrodes.

### Experimental Example 4. Structural Stability of c-IPN Cathode

To elucidate the fundamental properties of the c-IPN binder, films were prepared as described below, and their characteristics were evaluated, as shown in FIGS. 13A to 13H.

PVDF Film: The PVDF film was prepared by dissolving PVDF in N-methyl-2-pyrrolidone to create a coating solution. This solution was then applied onto a substrate and dried to form the film.

n-IPN film: A coating solution was prepared by adding PVDF and the crosslinking agent TMPTA in a 3:2 weight ratio to N-methyl-2-pyrrolidone. This coating solution was then applied to a substrate and dried to produce the film.

TMPTA/VAI-TFSI film: A coating solution was prepared by adding the crosslinking agent TMPTA and VAI-TFSI produced in Example 1 in a 0.7:1.3 weight ratio to N-methyl-2-pyrrolidone. This coating solution was then applied to a substrate and dried to produce the film.

c-IPN film: A coating solution was prepared by adding PVDF, the crosslinking agent TMPTA, and VAI-TFSI produced in Example 1 in a 3:0.7:1.3 weight ratio to N-methyl-2-pyrrolidone. This coating solution was then applied to a substrate and dried to produce the film.

FIG. 13A shows the Fourier Transform Infrared (FT-IR) spectra of the c-IPN films before and after heat cross-linking, focusing on the characteristic peaks assigned to the acrylic C═C bonds.

As shown in FIG. 13A, the disappearance of peaks assigned to TMTPA (v_{C=O} and V_{C—H}) and VAI-TFSI (v_{N—H} and v_{C—F}), as well as the characteristic peaks of the acrylic C═C bonds, observed in the Fourier Transform Infrared (FT-IR) spectra confirms the successful synthesis of the cross-linked copolymer network in the c-IPN films.

FIGS. 14A to 14D show the differential scanning calorimetry (DSC) profiles of the glass transition temperatures (Tg) for pristine PVDF films (A), pristine TMPTA/VAI-TFSI cross-linked copolymer films (B), and c-IPN films (C, D).

As shown in FIGS. 14A to 14D, the c-IPN films exhibited two distinct glass transition temperatures (−31° C. and 70° C.), which closely match the temperatures of the pristine PVDF (−35° C.) and the cross-linked copolymer (71° C.), respectively. This indicates the phase separation of PVDF and the cross-linked copolymer in the c-IPN, a typical feature of the IPN structure.

FIG. 13B shows the stress-strain curves for PVDF, n-IPN, and c-IPN films. As shown in FIG. 13B, the c-IPN and n-IPN films exhibited higher mechanical toughness than the PVDF films due to their interpenetrating polymer networks. However, the c-IPN films had higher toughness and lower modulus compared to the n-IPN films. This can be attributed to the loosely cross-linked network formed by the copolymerization of TMPTA (a cross-linker with three double bonds) and VAI-TFSI (a monomer with two double bonds). This result suggests that the c-IPN binder can be mechanically resistant to transverse internal stress caused by solvent drying during electrode fabrication.

FIG. 13C shows a graph of adhesion strength measured by the 180° peel test as a function of M/A for electrodes manufactured from Comparative Example 1 (PVDF), Comparative Example 2 (n-IPN), and Example 1 (c-IPN).

FIGS. 15A to 15C show the adhesion strength between the electrode active layers and the Al current collectors for PVDF (A), n-IPN (B), and c-IPN (C) electrodes with varying M/A values.

As shown in FIGS. 13C and 15A to 15C, the adhesion strength tended to decrease with increasing M/A. Notably, when the M/A value was 30 mg cm⁻² or higher, there was a distinct difference in adhesion strength between the c-IPN (Example 1) and n-IPN electrodes compared to the PVDF electrodes.

FIG. 13D shows a photographic image of an electrode manufactured from Comparative Example 1 (PVDF) with an M/A value of 50 mg cm⁻², while FIG. 13E shows a photographic image of an electrode manufactured from Example 1 (c-IPN) with an M/A value of 96 mg cm⁻².

As shown in FIGS. 13D and 13E, the PVDF electrode with an M/A of 50 mg cm⁻² exhibited severe cracking and delamination, consistent with previously reported results. In contrast, the electrode from Example 1 (c-IPN) maintained dimensional integrity without cracking, even at a higher M/A of 96 mg cm⁻².

FIG. 13F shows a cross-sectional scanning electron microscopy (SEM) image and energy-dispersive X-ray spectroscopy (EDS) image of an electrode manufactured from Example 1 (c-IPN) with an M/A of 96 mg cm⁻².

As shown in FIG. 13F, the electrode from Example 1 (c-IPN) exhibits a tight interface contact between the electrode active layer (thickness ˜390 μm) and the Al current collector. The elements Ni and C, originating from NCM811 and carbon black additives/binders, respectively, are uniformly distributed along the thickness of the electrode. This confirms that the electrode from Example 1 (c-IPN) maintains dimensional integrity without cracking, even at a higher M/A of 96 mg cm⁻².

FIG. 13G shows graphs of thickness and electrode density (p) as functions of M/A for electrodes manufactured from Example 1 (c-IPN) after roll pressing. FIG. 13H illustrates the electrode density as a function of C/A for the electrodes manufactured from Example 1 (c-IPN) compared to previously reported high M/A electrodes.

As shown in FIGS. 13G and 13H, in addition to the previously mentioned high M/A, the electrodes from Example 1 (c-IPN) exhibited a consistent electrode density of 2.8 g cm⁻³ across the entire range of M/A values, exceeding those of previously reported high M/A electrodes.

### Experimental Example 5. Uniformity of Redox Over the Entire Thickness of the c-IPN Cathode: Maintaining the Theoretical Csp of NCM811

The electrochemical performance evaluation results of cells combining cathodes manufactured from Comparative Example 1 (n-IPN) and Example 1 (c-IPN) with a 100 μm Li-metal anode (C/A=20 mAh cm⁻²) are shown in FIGS. 16A to 16F, 17A, 17B and 18A to 18C.

FIG. 16A shows the constant current charge/discharge profiles at 25° C. for cells using cathodes manufactured from Example 1 (c-IPN) with different cathode M/A values.

As shown in FIG. 16A, the capacity (C/A) of the cathodes manufactured from Example 1 (c-IPN) increases proportionally with the increase in M/A.

FIG. 16B shows the specific capacity (Csp) as a function of M/A for cathodes manufactured from Example 1 (c-IPN) and Comparative Example 1 (n-IPN) at a discharge current rate of 0.1 C. The dashed line represents the theoretical specific capacity of NCM811 (˜210 mAh/g).

FIG. 17 shows the constant current charge/discharge profiles as a function of cathode M/A (26-96 mg cm⁻²) at charge/discharge current rates of 0.05 C/0.1 C and within a voltage range of 3.0-4.4 V for cells combining cathodes manufactured from Comparative Example 1 (n-IPN) (a) and Example 1 (c-IPN) (b) with a Li-metal anode.

As shown in FIGS. 16b and 17, the cathodes manufactured from Example 1 (c-IPN) maintained the theoretical specific capacity of NCM811 (˜210 mAh/g_{NCM811}) even at an M/A of 96 mg/cm² (corresponding to a C/A of 20 mAh/cm²). In contrast, the cathodes manufactured from Comparative Example 1 (n-IPN) exhibited a sharp decline in specific capacity at M/A values above 59 mg/cm².

FIG. 18 includes: (a) A graph showing discharge rate performance (indicated as Csp) as a function of M/A for cells combining cathodes manufactured from Comparative Example 1 (n-IPN) and Example 1 (c-IPN) with a Li-metal anode. (b) Constant current charge/discharge profiles for cells using high M/A (65 mg cm⁻²) cathodes from Comparative Example 1 (n-IPN) at discharge current rates of 0.05 C (0.68 mA/cm²) to 0.5 C (6.75 mA/cm²). (c) Constant current charge/discharge profiles for cells using high M/A (65 mg/cm²) cathodes from Example 1 (c-IPN) at discharge current rates of 0.05 C (0.68 mA/cm²) to 0.5 C (6.75 mA/cm²).

As shown in FIG. 18, the difference in Csp between the cathodes manufactured from Example 1 (c-IPN) and Comparative Example 1 (n-IPN) became more pronounced at higher discharge current rates and higher M/A values. Meanwhile, PVDF cathodes were excluded from this comparison because they could not be used to manufacture high M/A cathodes.

FIG. 16C shows the specific energies of cells using cathodes manufactured from Example 1 (c-IPN) and Comparative Example 1 (n-IPN) as a function of M/A, with the packaging materials excluded.

The ultimate goal of high M/A electrodes is to achieve high energy density (=voltage×C/A, where C/A=M/A×Cₛₚ). However, as shown in Table 3, previous studies on high M/A electrodes often overlooked the importance of Cₛₚ.

In contrast, as shown in FIG. 16C and Table 1, the cathodes manufactured from Example 1 (c-IPN) consistently increased the specific energy of the cells with rising M/A values, ultimately reaching a plateau of 431 Wh kg-1 at an M/A of 96 mg cm⁻². In contrast, the specific energy of cells using cathodes from Comparative Example 1 (n-IPN) decreased as M/A increased beyond 59 mg cm⁻², which is consistent with the Cₛₚ results (FIG. 16B).

FIG. 16D shows a cross-sectional optical microscopy image of a cathode (M/A=65 mg cm⁻²) manufactured from Example 1 (c-IPN) after charging at a current density of 1.1 mA cm⁻² to 4.4 V and subsequently disassembled. The top and bottom regions indicated in the image correspond to the areas selected for Raman spectroscopy, as shown in FIGS. 16e-f and FIG. 20.

FIG. 16E shows the Raman spectra and the intensity ratio of Eg/A1g for the top and bottom regions of cathodes manufactured from Comparative Example 1 (n-IPN), while FIG. 16F shows the corresponding Raman spectra and Eg/A1g ratio for cathodes from Example 1 (c-IPN). In this context, Eg and A1g refer to the metal-oxygen-metal bending modes along the a/b axes, with Eg corresponding to the metal-oxygen-metal mode in the a/b directions and A1g representing the stretching mode of the metal-oxygen complexes along the c-axis.

FIG. 19 shows a cross-sectional optical microscopy image of a cathode manufactured from Comparative Example 1 (n-IPN) with an M/A of 65 mg cm⁻².

To further explain the difference in Csp between the cathodes manufactured from Example 1 (c-IPN) and Comparative Example 1 (n-IPN), the state of charge (SOC) was analyzed along the thickness direction. As shown in FIGS. 16D and 19, the distance from the Al current collector (labeled as “top” and “bottom”) was measured, and confocal Raman spectroscopy was used to investigate the local SOC values as a function of this distance.

As shown in FIGS. 16E-F, the Raman spectra, where the intensity ratio of E_{g}/A_{1g} tends to increase with the state of charge (SOC) of the anode active material (i.e., the degree of delithiation), revealed that at 100% SOC, the cathodes manufactured from Comparative Example 1 (n-IPN) exhibited a lower E_{g}/A_{1g} intensity ratio in the bottom region. This indicates that NCM811 in these cathodes experiences less delithiation in the bottom region (adjacent to the Al current collector) due to the uneven and tortuous pathways for Li⁺ in the cathode. In contrast, the E_{g}/A_{1g} intensity ratio of the cathodes manufactured from Example 1 (c-IPN) remained almost constant across the cross-section, confirming uniformity in the redox reactions of NCM811 throughout the entire thickness.

FIGS. 20A and 20B show the Raman spectra and the intensity ratio of E_{g}/A_{1g} for cathodes with low M/A (26 mg cm⁻²) manufactured from Comparative Example 1 (n-IPN) (a) and Example 1 (c-IPN) (b) after charging at a current rate of 0.2 C (1.1 mA cm⁻²). The spectra are presented for the top and bottom regions of the cathodes.

As shown in FIGS. 20A and 20B, there is no significant difference in the E_{g}/A_{1g} ratio between the top and bottom regions of cathodes with low M/A (26 mg cm⁻²) compared to those with high M/A. This indicates that the redox uniformity observed in the cathodes manufactured from Example 1 (c-IPN) is attributed more to Li⁺ transport rather than electronic conductivity across the thickness.

FIG. 21 presents a comparison of the electronic conductivity of cathodes manufactured from Example 1 (c-IPN) and Comparative Example 1 (n-IPN) as a function of M/A. The measurements were obtained using a four-point probe station. As shown in FIG. 21, the electronic conductivity of the cathodes at an M/A of 65 mg cm 2 is negligible, indicating that the difference in the E_{g}/A_{1g} intensity ratio between the two cathodes is primarily due to the slower ion transport in the thickness direction of the cathodes manufactured from Comparative Example 1 (n-IPN). This result is consistent with previous studies on high M/A electrodes, which emphasize the importance of ion transport in achieving redox uniformity.

### Experimental Example 6. Reinforcing Li+ Conductivity Inside the Cathode by c-IPN Binder

Binders are known to act as adhesives between cathode active materials, and since they do not fully cover the cathode active material, a significant portion of the active material is exposed to the electrolyte. In Example 1, the c-IPN binder can influence the surface charge environment of the gaps and pores filled with electrolyte in the electrode, contributing to the facilitation of Li⁺ transport as described above. The imidazolium-based cationic groups in the c-IPN binder can electrostatically interact with the anions (PF₆⁻) of the liquid electrolyte (1M LiPF₆ in ethyl carbonate (EC)/diethyl carbonate (DEC)=1/1 (v/v)). Experimental results demonstrating this effect are shown in FIGS. 22A to 22G.

FIG. 22A shows the FT-IR spectra of cathodes manufactured from Example 1 (c-IPN) and Comparative Example 1 (n-IPN) when in contact with the liquid electrolyte (1M LiPF₆ in EC/DEC=1/1 (v/v)). FIG. 22A focuses on the characteristic vibrational peak of the PF₆⁻ bond at 836 cm⁻¹.

As shown in FIG. 22A, a downward shift in the vibrational peak of the P—F bond at 836 cm⁻¹ was observed in the cathodes manufactured from Example 1 (c-IPN) compared to those from Comparative Example 1 (n-IPN). This indicates that the c-IPN binder in Example 1 facilitates electrostatic interactions between the imidazolium cationic groups and the PF₆⁻ anions in the liquid electrolyte.

FIG. 22B presents the results of 7Li magic angle spinning (MAS) nuclear magnetic resonance (NMR) spectroscopy at the binder-electrolyte interface for cathodes manufactured from Example 1 (c-IPN) and Comparative Example 1 (n-IPN).

As shown in FIG. 22B, analysis of the local environment of Li⁺ in the electrolyte-filled pores of the cathodes manufactured from Example 1 (c-IPN) revealed a downward shift and a narrower peak in the 7Li NMR spectrum compared to those from Comparative Example 1 (n-IPN). This observation indicates improved dissociation of Li salts and enhanced mobility of free Lit ions in the c-IPN-based cathodes.

Using the normalized intensity of the 7Li-NMR spectra (I/I₀) as a function of time from FIG. 22B, the spin-lattice relaxation time (T1) values were obtained and are presented in FIG. 23.

FIG. 23 shows the inversion-recovery plots obtained from the 7Li MAS NMR spectra of cathodes manufactured from Example 1 (c-IPN) and Comparative Example 1 (n-IPN). The spin-lattice relaxation time (T1) presented in FIG. 23 was calculated using the following Equation 6.

$$I = {I}_{0} ( 1 - {exp}^{- t / {T}_{1}} ) \qquad [ Equation 6 ]$$

In Equation 6, I represents the peak intensity at time t, and I₀ denotes the saturation intensity.

As shown in FIG. 23, the cathodes manufactured from Example 1 (c-IPN) exhibited a smaller T₁ value (737 ms) compared to those from Comparative Example 1 (n-IPN) (957 ms). Considering that a smaller T1 value reflects a faster ion diffusion rate, this indicates that the cathodes from Example 1 exhibit improved Li⁺ mobility in the electrolyte-filled pores.

FIGS. 22C and 22D show the radial distribution function (RDF) profiles of the P atoms of PF₆⁻ and Li atoms at the binder-electrolyte interface for cathodes manufactured from Example 1 (c-IPN) and Comparative Example 1 (n-IPN), obtained from electrochemical impedance spectroscopy (EIS) analysis of a symmetric cell (electrode∥electrode) at 0% state of charge (SOC).

As shown in FIG. 22C, analysis of the radial distribution function (RDF) for PF₆⁻ and Li⁺ ions at the binder-electrolyte interface revealed that, for the Comparative Example 1 (n-IPN) binder, the RDF for PF₆⁻ gradually increased with distance (r) from the n-IPN binder surface. In contrast, the binder from Example 1 (c-IPN) exhibited a distinct peak at r=5.0 Å, indicating that PF₆⁻ is predominantly present around the surface of the cathode manufactured from Example 1 (c-IPN).

As shown in FIG. 22D, analysis of the radial distribution function (RDF) for Li⁺ as a function of r revealed that the binder from Example 1 (c-IPN) exhibited a characteristic peak at a larger r (6.5 Å) compared to the binder from Comparative Example 1 (n-IPN) (2.0 Å). This indicates that the binder from Example 1 (c-IPN) causes Li⁺ ions to be located further from the binder due to electrostatic repulsion from the positively charged imidazolium groups in the c-IPN binder.

Electrochemical Impedance Spectroscopy (EIS) analysis was performed on a symmetric cell to investigate the ionic conductivity (σ_{electrode}) within the electrolyte-filled pores of the electrode. The results are depicted in FIGS. 24A to 24C.

Additionally, the slope observed in the low-frequency region of the Nyquist plot is known to reflect the ionic resistance within the electrode (Rᵢₒₙ/3, σ_{electrode}=1/Rᵢₒₙ). Therefore, WO was used to estimate Rᵢₒₙ/3, and Rᵢₒₙ was used to calculate the ionic conductivity within the cathode (σ_{electrode}=1/Rᵢₒₙ).

FIGS. 24A to 24C show the Nyquist plots for symmetric cells (electrode∥electrode) containing cathodes with high M/A (=65 mg cm 2) that are fully lithiated, as manufactured in the comparative example 1 (n-IPN) (A) and the embodiment example 1 (c-IPN) (B). It also includes the equivalent circuit using the generalized finite length Warburg element open circuit terminus (WO) (C). In FIG. 24 (a-b), the symbols and solid lines represent the experimental data and the fitting curves based on the transmission line equivalent circuit model (TLM), respectively.

FIGS. 25A and 25B illustrate the following for cathodes with high M/A (=65 mg cm⁻²) manufactured in Comparative Example 1 (n-IPN) and Embodiment Example 1 (c-IPN): (A) Galvanostatic Intermittent Titration Technique (GITT) Profile: Shows the GITT profiles under repeated current pulses at a discharge current rate of 0.1 C(=1.35 mA cm⁻²). (B) Discharge Steps in GITT: Displays the discharge steps obtained from the GITT profiles.

In FIG. 25, the lithium ion diffusion coefficient (DLi+) was calculated using the following Equation 7, and the specific calculation details are provided in Table 5 below.

$${D}_{{Li}^{+}} = \frac{4}{πΔτ} ( \frac{{m}_{B} {V}_{M}}{{M}_{B} S} ) {( \frac{Δ {E}_{s}}{Δ {E}_{t}} )}^{2} \qquad [ Equation 7 ]$$

In Equation 7, m_{B} represents the mass of the electrode active material, S is the geometric area of the electrode, M_{B} is the molar mass of the electrode material, and V_{M} is the molar volume of the electrode material. Other parameters ((Δt, ΔEₜ and ΔEₛ)) are shown in FIGS. 25A and 25B.

TABLE 5

| | | M_{B} | V_{M} | m_{B} S⁻¹ | | | |
|---|---|---|---|---|---|---|---|
| | Δt | (g | (cm³ | (mg | ΔEₛ | ΔEₜ | D_{Li+} |
| | (s) | mol⁻¹) | mol⁻¹) | cm⁻²) | (mV) | (mV) | (cm² s⁻¹) |
| n-IPN | 3600 | 97.28 | 20.53 | 64.56 | 61.11 | 158.98 | 9.69 E−09 |
| c-IPN | 3600 | 97.28 | 20.53 | 64.48 | 51.54 | 86.52 | 2.32 E−08 |

FIG. 22E shows an Arrhenius plot of the ionic conductivity of the electrolyte-filled pores in cathodes (M/A=65 mg cm⁻²) manufactured from Example 1 (c-IPN) and Comparative Example 1 (n-IPN).

As shown in FIGS. 22E, 24A to 24C, 25A and 25B, the cathode manufactured in Example 1 (c-IPN) demonstrated higher σ-electrode and lower activation energy (Ea) over a wider temperature range compared to the cathode manufactured in Comparative Example 1 (n-IPN).

FIG. 22F shows a graph representing the internal resistance (Rᵢₙₜₑᵣₙₐₗ) and D_{Li+} as functions of discharge voltage for the cathodes manufactured in Example 1 (c-IPN) and Comparative Example 1 (n-IPN) with an M/A ratio of 65 mg cm⁻². This data was estimated from the results of the galvanostatic intermittent titration technique (GITT) at 25° C.

As shown in FIG. 22f and Table 5, the cell with the cathode manufactured in Example 1 (c-IPN) exhibited a lower internal resistance (Rᵢₙₜₑᵣₙₐₗ) during discharge reactions and a higher Li⁺ diffusion coefficient (D_{Li+}) across the entire voltage range.

FIG. 26 shows (a) the weight change and (b) the before (left) and after (right) images of the electrolyte absorption of the cathodes manufactured in Comparative Example 1 (n-IPN) and Example 1 (c-IPN), after immersing them in a liquid electrolyte (1M LiPF6 in EC/DEC=1/1 (v/v)) for 2 hours.

As shown in FIG. 26, the difference in electrolyte absorption between the cathodes manufactured in Example 1 (c-IPN) and Comparative Example 1 (n-IPN) was negligible, indicating that the facile Li⁺ transport in the cathode manufactured in Example 1 (c-IPN) is almost independent of the amount of electrolyte within the cathode.

FIG. 22g is a schematic diagram illustrating the role of the binder according to an embodiment of the present invention.

As shown in FIG. 22g, the binder according to an embodiment of the present invention is evenly distributed inside the cathode through electrostatic attraction with PF₆− and electrostatic repulsion with Lit in the liquid electrolyte, facilitating the distribution of freely moving Lit and a uniform distribution of Li⁺ concentration.

### Experimental Example 7. Improvement of Cycling Performance Through c-IPN and Mechanical Understanding

Using the cathode manufactured in Example 1 (c-IPN), a Li-metal full cell (cathode (C/A=13.5 mAh cm⁻²)∥Li-metal anode (C/A=20.0 mAh cm⁻², N/P ratio=1.5)) was constructed. The cell's cycling performance was analyzed under charging/discharging current densities of 0.68/1.35 mA cm⁻² and a voltage range of 3.0-4.4 V at 25° C., and the results are shown in FIG. 27 and FIG. 28.

FIG. 27a shows the cycling performance of Li metal full cells using cathodes (M/A=65.0 mg cm⁻²) manufactured in Comparative Example 1 (n-IPN) and Example 1 (c-IPN).

FIG. 28 shows the constant current charging/discharging profiles of Li metal full cells using cathodes manufactured in Comparative Example 1 (n-IPN) (a) and Example 1 (c-IPN) (b) for the 1st, 50th, and 100th cycles.

As shown in FIG. 27a and FIG. 28, the cell using the cathode manufactured in Example 1 (c-IPN) exhibited a higher initial Cₛₚ (˜210 mAh g_{NCM811}⁻¹) compared to the cell using the cathode from Comparative Example 1 (n-IPN) (˜185 mAh g_{NCM811}⁻¹). After 100 cycles under limited cell conditions, the capacity retention was 82% for Example 1 (c-IPN) and 16% for Comparative Example 1 (n-IPN), indicating that the cell with the cathode from Example 1 (c-IPN) demonstrated a higher cycling stability.

To provide a more detailed explanation of the impact of the cathode manufactured in Example 1 (c-IPN) on cycling performance, the EIS spectra of the cells were analyzed, and the results are presented in FIGS. 29A to 29C and Table 6.

FIGS. 29A to 29C show the Nyquist plots for Li-metal full cells using cathodes manufactured in Comparative Example 1 (n-IPN) and Example 1 (c-IPN) during the first (A) and 50th (B) cycles. It also includes (C) the equivalent circuit used for the plots. In FIG. 29 (a-b), the symbols and solid lines represent experimental data and fitted curves, respectively.

Table 6 presents the results of the equivalent circuit element analysis as a function of the number of cycles, obtained from the Nyquist plots in FIG. 29.

TABLE 6

| | Impedance | | |
|---|---|---|---|
| Cathode | (ohm cm²) | 1^{st} cycle | 50^{th} cycle |
| n-IPN | R_{film} | 9.3 | 79.8 |
| | R_{ct} | 17.0 | 47.0 |
| c-IPN | R_{film} | 9.2 | 23.6 |
| | R_{ct} | 4.0 | 33.6 |

As shown in FIGS. 29A to 29C and Table 6, the cathode manufactured in Example 1 (c-IPN) exhibited lower cell resistance than the cathode in Comparative Example 1 (n-IPN) during the first cycle. This indicates that the binder in Example 1 (c-IPN) facilitates the free movement of Li⁺ ions and contributes to a more uniform distribution of Li⁺ concentration in the high C/A cathode. Furthermore, after the 50th cycle, the lower cell resistance was still observed in Example 1 (c-IPN), suggesting the formation of a stable CEI in NCM811, which positively impacts cycling performance.

To investigate the CEI formed on NCM811, the NCM811 from cycled cathodes was analyzed using X-ray photoelectron spectroscopy (XPS) depth profiling as a function of etching time. The results are presented in FIGS. 27B-C and 30A to 30C.

FIG. 27B shows the XPS (X-ray photoelectron spectroscopy) depth profile of the cycled cathodes manufactured in Comparative Example 1 (n-IPN), while FIG. 27C illustrates the XPS depth profile of the cycled cathodes manufactured in Example 1 (c-IPN).

FIGS. 30A to 30C show the X-ray photoelectron spectroscopy (XPS) profiles of cycled NCM811 from cathodes manufactured in Comparative Example 1 (n-IPN) and Example 1 (c-IPN). Specifically, it presents the C1s (a), F1s (b), and O1s (c) profiles.

As shown in FIGS. 27B, 27C, and 30A to 30C, Comparative Example 1 (n-IPN) exhibited a higher content of organic elements (reflected as C and O) primarily due to the decomposition of carbonate solvents in the electrolyte. In contrast, Example 1 (c-IPN) showed a higher content of inorganic elements (e.g., Li and F) over a broad etching time, attributed to the formation of a LiF-rich component. A LiF-rich CEI layer is known to help mitigate undesirable interfacial side reactions with the electrolyte, which positively contributes to the cycle life.

Additionally, the XPS F1s spectrum of cycled NCM811 from the cathode manufactured in Example 1 (c-IPN) indicates a predominant presence of LiF (at 685.5 eV). It is known that LiF in the CEI layer has a beneficial effect on cycling stability. This finding is corroborated by the strong peak detected at 529.8 eV in the 01s spectrum for Comparative Example 1 (n-IPN), which is attributed to M-O species (metal-oxygen), explaining the severe dissolution of transition metal ions.

FIGS. 31A to 31E show the normalized time-of-flight secondary ion mass spectrometry (TOF-SIMS) depth profiling after cycling for cathodes manufactured in Comparative Example 1 (n-IPN) (A) and Example 1 (c-IPN) (B). It also presents TOF-SIMS depth profiles for LiF₂(C), Li₂CO₃ (D), and C₂F (E).

As shown in FIGS. 31A to 31E, compared to the cathode manufactured in Comparative Example 1 (n-IPN), the cathode produced in Example 1 (c-IPN) exhibited lower intensities of organic components (e.g., Li₂CO₃⁻ and C₂F⁻) in the inner layers, and higher intensities of inorganic LiF₂⁻. This suggests that the unique CEI structure of the cathode in Example 1 (c-IPN) is consistent with the results of a LiF-rich CEI layer formed in LiPF₆⁻ based concentrated electrolytes.

FIG. 27D shows the FT-IR spectra of the liquid electrolyte (1M LiPF₆ in EC/DEC=1/1 (v/v)) used with cathodes manufactured in Comparative Example 1 (n-IPN) and Example 1 (c-IPN). The spectra are focused on the characteristic peaks attributed to the carbonyl stretching vibrations of the EC solvent, specifically at 1770 and 1800 cm⁻¹.

As shown in FIG. 27D, the differences in the CEI layers of the cathodes manufactured in Example 1 (c-IPN) and Comparative Example 1 (n-IPN) were further confirmed by investigating the Lit solvation structure of the liquid electrolyte inside the cathodes. In the FT-IR spectrum of the liquid electrolyte, two characteristic peaks assigned to the carbonyl stretching vibrations of the EC solvent were observed at 1770 and 1800 cm-1 for Comparative Example 1 (n-IPN). These peaks corresponded to Li+coordinated and free carbonate species, respectively. In contrast, in the FT-IR spectrum of Example 1 (c-IPN), the peak at 1770 cm-1 shifted downward with increasing intensity, indicating an increase in Li⁺ coordinated carbonates.

The Li⁺-solvent RDF (Radial Distribution Function) analysis and CN (Coordination Number) calculations were used to quantitatively determine the Li⁺ solvation structure within the liquid electrolyte inside the cathodes. The results are presented in FIGS. 32A and 32B.

FIGS. 32A and 32B show the radial distribution function (RDF) profiles and coordination numbers (CN) for the binder-electrolyte interfaces (EC (A) and DEC (B)) in the cathodes manufactured in Comparative Example 1 (n-IPN) and Example 1 (c-IPN). These profiles represent the solvation structure of Li⁺ ions with the solvents in the liquid electrolyte.

FIGS. 33A and 33B illustrate the radial distribution function (RDF) profiles (A) and coordination numbers (CN) (B) for the binder-electrolyte interface and the bulk electrolyte in cathodes manufactured in Comparative Example 1 (n-IPN) and Example 1 (c-IPN). The RDF profiles and CN values represent the interactions between Li⁺ and PF₆⁻ ions in the liquid electrolyte.

As shown in FIGS. 33A and 33B, the binder in Example 1 (c-IPN) exhibited a lower coordination number (CN) compared to the binder and bulk electrolyte in Comparative Example 1 (n-IPN). This indicates that, due to the electrostatic interactions between PF6− and the binder in Example 1 (c-IPN), the PF₆⁻ ions in the liquid electrolyte inside the cathode manufactured in Example 1 (c-IPN) are less coordinated by the solvent.

In other words, the cathode manufactured in Example 1 (c-IPN) exhibits a relatively higher coordination number (CN) between Li⁺ and the solvent in the liquid electrolyte, while showing a lower CN between Li⁺ and PF₆⁻ (as seen in FIGS. 33A and 33B). This confirms the presence of electrostatic interactions between PF₆⁻ and the binder in Example 1 (c-IPN).

The Li⁺ solvation structure within the liquid electrolyte of the cathode was theoretically investigated using molecular dynamics (MD) simulations, and the results are presented in Table 7.

Table 7 provides detailed information about the model systems for the binders in Comparative Example 1 (n-IPN) and Example 1 (c-IPN). The initial density of the systems was obtained from experimental results.

TABLE 7

| | | Bulk | Bulk | n-IPN/ | c-IPN/ |
|---|---|---|---|---|---|
| | | n-IPN | c-IPN | electrolyte | electrolyte |
| Number | TMTPA | 17 | 7 | 17 | 7 |
| of | chains | | | | |
| | VA [symbol] -TFS [symbol] | — | 10 | — | 10 |
| | chains | | | | |
| | EC | — | — | 560 | 650 |
| | DEC | — | — | 308 | 358 |
| | LIPF₆ | — | — | 143 | 166 |

| | | | | |
|---|---|---|---|---|
| Size of the system | 4.1 × | 4.4 × | 4.1 × | 4.4 × |
| (mm³) | 4.1 × 4.1 | 4.4 × 4.4 | 4.1 × 14.0 | 4.4 × 14.5 |

[symbol]

indicates data missing or illegible when filed

FIG. 27E is a graph showing the relative proportion of Li⁺ solvation structures in the liquid electrolyte inside the cathodes manufactured in Comparative Example 1 (n-IPN) and Example 1 (c-IPN).

FIGS. 34A and 34B illustrate the HOMO (Highest Occupied Molecular Orbital) energy levels and the relative proportions of Li⁺ solvation structures in the liquid electrolyte (1M LiPF₆ in EC/DEC=1/1 (v/v)) for the cathodes manufactured in Comparative Example 1 (n-IPN) (A) and Example 1 (c-IPN) (B). The primary Li⁺ solvation structures are highlighted in red.

The Lit solvation structures are denoted as X-Y-Z-(A), where: X represents the number of EC molecules coordinated with Lit, Y represents the number of DEC molecules coordinated with Li⁺, Z represents the number of PF₆⁻ ions coordinated with Lit, A represents the number of TFSI⁻ ions coordinated with Lit.

As shown in FIGS. 27E, 34A and 34B, compared to Comparative Example 1 (n-IPN), the cathode manufactured in Example 1 (c-IPN) exhibited an increased ratio of Li⁺ coordinated carbonates and a decreased ratio of dissociated LiPF₆⁻ carbonate complexes. It was observed that the predominant Lit solvation structure within Example 1 (c-IPN) was a 5-0-0 configuration (Li⁺ coordinated with 5 EC solvents, 0 DEC solvents, and 0 PF₆⁻). In contrast, the solvation structure in the cathode manufactured in Comparative Example 1 (n-IPN) was a 3-0-2 configuration.

The HOMO (Highest Occupied Molecular Orbital) energy levels of the primary Li+ solvation structures were determined using density functional theory (DFT) calculations, as shown in FIG. 27F.

FIG. 27F illustrates the (f) HOMO (Highest Occupied Molecular Orbital) energy levels of the primary Li⁺ solvation structures and (g) the binding energies between the electrolyte components (PF₆⁻ and EC) and Li⁺ for the cathodes manufactured in Comparative Example 1 (n-IPN) and Example 1 (c-IPN).

As shown in FIGS. 27F-27G, the solvation structure of the cathode manufactured in Example 1 (c-IPN) exhibited lower HOMO energy levels compared to that of Comparative Example 1 (n-IPN). This is attributed to the difficulty in oxidizing the coordination complexes close to the binder in Example 1 (c-IPN). Additionally, the 5-0-1 Lit solvation structure in Example 1 (c-IPN) showed lower binding energies between Li⁺ and PF₆⁻ compared to Comparative Example 1 (n-IPN). This indicates that PF₆⁻ is weakly bound to Lit in Example 1 (c-IPN) due to electrostatic interactions with the binder. Consequently, PF₆⁻ adjacent to the binder in the cathode manufactured in Example 1 (c-IPN) is more prone to decomposition, promoting the formation of a LiF-rich CEI layer.

### Experimental Example 8. Structural Characteristics of Cyclized NCM811

The structural changes in the cycled NCM811 were analyzed using focused ion beam (FIB) tomography and high-resolution transmission electron microscopy (HR-TEM), with the results presented in FIGS. 35A to 35H, 36A and 36B.

FIGS. 35A to 35H show the following for the cycled NCM811 in cathodes manufactured in Comparative Example 1 (n-IPN) (A, C, E, G) and Example 1 (c-IPN) (B, D, F, H): Scanning Electron Microscopy (SEM) images of cross-sections (A, B), High-Resolution Transmission Electron Microscopy (HR-TEM) images (C, D), Fast Fourier Transform (FFT) patterns (E, F).

FIGS. 36A and 36B show the cross-sectional scanning electron microscopy (SEM) images of cycled NCM811 particles in the cathodes manufactured in Comparative Example 1 (n-IPN) (a) and Example 1 (c-IPN) (b).

As shown in FIGS. 36A and 36B, electrolyte penetration into grain boundary cracks can continuously induce the formation of new primary particles and unwanted interfacial side reactions, potentially degrading cycling stability.

As shown in FIGS. 35A, 36A and 36B, the cycled NCM811 in the cathodes manufactured in Comparative Example 1 (n-IPN) exhibited significant grain boundary cracks along with microcracks due to anisotropic deformation. In contrast, the cycled NCM811 in the cathodes manufactured in Example 1 (c-IPN) maintained structural integrity with no noticeable cracks or interruptions.

As shown in FIGS. 35C-D, the cycled NCM811 in the cathodes manufactured in Example 1 (c-IPN) exhibited a thin and uniform CEI layer. In contrast, the cycled NCM811 in the cathodes manufactured in Comparative Example 1 (n-IPN) displayed a thick and uneven CEI layer.

As shown in FIGS. 35E-G, the layered structure of cycled NCM811 in the cathodes manufactured in Comparative Example 1 (n-IPN) was almost completely lost, as confirmed by the FFT (Fast Fourier Transform) patterns indicating an amorphous phase. In contrast, the cycled NCM811 in the cathodes manufactured in Example 1 (c-IPN) retained its initial layered structure (R3m phase) stably in the bulk region (indicated as area #1 in FIGS. 35F and H), while a NiO-type rock-salt structure (Fm3m phase) was observed in a thin outer layer (˜6 nm, area #2). The structural stability of the cycled NCM811 in the cathodes manufactured in Example 1 (c-IPN) can explain the capacity recovery of the dual-layer pouch cells shown in FIG. 2D.

### Experimental Example 9. Structural Characteristics of Cyclized NCM811

FIGS. 37A and 37B present the following: (a) Photographic images of the cathodes manufactured in Comparative Example 1 (PVdF), Example 1 (TMPTA), Example 2 (TPPTA), and Example 3 (ETPTA), along with their critical crack thickness (CCT) and critical delamination thickness (CDT) values. (b) Graphs showing the bulk resistance (R_{Bulk}) and interfacial resistance (R_{Interfacial}) for the cathodes manufactured in Example 1 (TMPTA) and Example 3 (ETPTA).

As shown in FIG. 37A, it is evident that the cracking phenomenon is significantly suppressed in the embodiments of the present invention compared to Comparative Example 1, where PVDF is used alone. Moreover, as the crosslinker length and molecular weight increase in the order of TMPTA→ETPTA→TPPTA, the electrode layer delamination observed in Example 2 (TPPTA), which has the largest molecular weight, is notably different from other examples. This is because, as the crosslinker length and molecular weight increase, the Young's modulus decreases, accelerating the delamination phenomenon after roll pressing.

As shown in FIG. 37B, it can be observed that among Example 1 (TMPTA) and Example 3 (ETPTA), Example 1 (TMPTA) exhibits a significantly reduced interfacial resistance.

While the embodiments of the present invention have been described, it will be apparent to those skilled in the art that various modifications and changes can be made without departing from the spirit of the invention as defined in the claims. Such modifications, including additions, alterations, or deletions of components, are intended to be within the scope of the invention.

The references cited in the experimental examples of the specification of the present invention are as follows:
1. Choi, J. W. & Aurbach, D. Promise and reality of post-lithium-ion batteries with high energy densities. Nat. Rev. Mater. 1,1 (2016).
2. Albertus, P., Babinec, S., Litzelman, S. & Newman, A. Status and challenges in enabling the lithium metal electrode for high-energy and low-cost rechargeable batteries. Nat. Energy 3, 16-21 (2017).
3. Wu, J. et al. From Fundamental Understanding to Engineering Design of High-Performance Thick Electrodes for Scalable Energy-Storage Systems. Adv. Mater. 33, e2101275 (2021).
4. Kim, J. H., Kim, J. M., Cho, S. K., Kim, N. Y.& Lee, S. Y. Redox-homogeneous, gel electrolyte-embedded high-mass-loading cathodes for high-energy lithium metal batteries. Nat. Commun. 13, 2541 (2022).
5. Kuang, Y., Chen, C., Kirsch, D. & Hu, L. Thick Electrode Batteries: Principles, Opportunities, and Challenges. Adv. Energy Mater. 9 (2019).
6. Park, S.-H. et al. High areal capacity battery electrodes enabled by segregated nanotube networks. Nat. Energy 4, 560-567 (2019).
7. Routh, A. F. Drying of thin colloidal films. Rep. Prog. Phys. 76, 046603 (2013).
8. Du, Z., Wood, D. L., Daniel, C., Kalnaus, S. & Li, J. Understanding limiting factors in thick electrode performance as applied to high energy density Li-ion batteries. J. Appl. Electrochem. 47, 405-415 (2017).
9. Heubner, C., Schneider, M. & Michaelis, A. Diffusion-Limited C-Rate: A Fundamental Principle Quantifying the Intrinsic Limits of Li-Ion Batteries. Adv. Energy Mater. 10 (2019).
10. Park, K.-Y. et al. Understanding capacity fading mechanism of thick electrodes for lithium-ion rechargeable batteries. J. Power Sources 468, 228369 (2020).
11. Zhao, Z. et al. Sandwich, Vertical-Channeled Thick Electrodes with High Rate and Cycle Performance. Adv. Funct. Mater. 29, 1809196 (2019).
12. Chen, C. et al. Highly Conductive, Lightweight, Low-Tortuosity Carbon Frameworks as Ultrathick 3D Current Collectors. Adv. Energy Mater. 7, 1700595 (2017).
13. Wu, J. et al. Ultrahigh-Capacity and Scalable Architected Battery Electrodes via Tortuosity Modulation. ACS Nano 15, 19109 (2021).
14. Chen, S. et al. Critical Parameters for Evaluating Coin Cells and Pouch Cells of Rechargeable Li-Metal Batteries. Joule 3, 1094-1105 (2019).
15. Liu, J. et al. Pathways for practical high-energy long-cycling lithium metal batteries. Nat. Energy 4, 180-186 (2019).-
16. Noh, H.-J., Youn, S., Yoon, C. S. & Sun, Y.-K. Comparison of the structural and electrochemical properties of layered Li [NixCoyMnz] O2 (x=⅓, 0.5, 0.6, 0.7, 0.8 and 0.85) cathode material for lithium-ion batteries. J. Power Sources 233, 121-130 (2013).
17. Russel, W. B. Cracking in Drying Latex Films. Langmuir 21, 4938 (2005).
18. Kim, N. Y. et al. Amphiphilic Bottlebrush Polymeric Binders for High-Mass-Loading Cathodes in Lithium-Ion Batteries. Adv. Energy Mater. 12, 2102109 (2021).

What is claimed is:

1. A binder for secondary battery electrodes, the binder comprising a cationic semi-interpenetrating network polymer (semi-IPN).

2. The binder for secondary battery electrodes according to claim 1,
wherein the cationic semi-interpenetrating network polymer (semi-IPN) comprises a crosslinked polymer and a linear polymer.

3. The binder for secondary battery electrodes according to claim 2,
wherein the crosslinked polymer comprises a cationic unit derived from a cationic monomer and a multifunctional crosslinking unit derived from a multifunctional crosslinking monomer.

4. The binder for secondary battery electrodes according to claim 3,
wherein the cationic monomer includes one or more cationic groups selected from the group consisting of imidazolium, pyridinium, phosphonium, sulfonium, pyrrolidinium, guanidinium, ammonium, isouronium, thiouronium, piperidinium, pyrazolium, methylium, and morpholinium groups.

5. The binder for secondary battery electrodes according to claim 4,
wherein the cationic monomer further includes a counterion, and
the counterion is selected from the group consisting of BF₄⁻, B(CN)₄, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻ (TFSI⁻), N(COCF₃)(SO₂CF₃)⁻, N(SO₂F)₂⁻, N(CN)₂⁻, C(CN)₃⁻; SCN⁻, and SeCN⁻.

6. The binder for secondary battery electrodes according to claim 3,
wherein the multifunctional crosslinking monomer includes at least two polymerizable functional groups.

7. The binder for secondary battery electrodes according to claim 3,
wherein the multifunctional crosslinking monomer is selected from the group consisting of ethylene glycol diacrylate (EGDMA), triethylene glycol diacrylate (TEGDA), poly(ethylene glycol) diacrylate (PEGDA), 1,6-hexanediol diacrylate (HDDA), ethoxylated trimethylolpropane triacrylate (ETPTA), trimethylolpropane propoxylated triacrylate (TPPTA), pentaerythritol triacrylate (PETA), and trimethylolpropane triacrylate (TMPTA).

8. The binder for secondary battery electrodes according to claim 2,
wherein the crosslinked polymer is obtained by polymerizing the cationic monomer and the multifunctional crosslinking monomer at a weight ratio of 0.8 to 7:1.

9. The binder for secondary battery electrodes according to claim 2,
wherein the crosslinked polymer is represented by the following Chemical Formula 1: 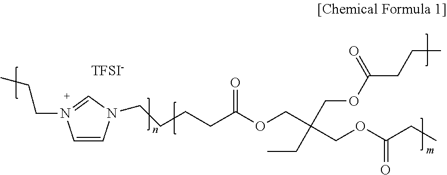
wherein the n and the m represent the polymerization degrees of each monomer unit, where the n is an integer from 1 to 400 and the m is an integer from 1 to 200.

10. The binder for secondary battery electrodes according to claim 2,
wherein the linear polymer is selected from the group consisting of cellulose-based polymers, acrylic-based polymers, and fluorine-containing polymers.

11. The binder for secondary battery electrodes according to claim 2,
wherein the linear polymer is included in an amount of 45 to 100 parts by weight relative to 40 parts by weight of the crosslinked polymer.

12. An electrode comprising the binder for secondary battery electrodes according to claim 1.

13. The electrode according to claim 12,
wherein the binder for secondary battery electrodes is included in an amount of 1 to 10 parts by weight relative to 100 parts by weight of the entire electrode.

14. A secondary battery comprising an electrode according to claim 12.

15. A device comprising the secondary battery of claim 14,
wherein the device is selected from the group consisting of a communication device, a transportation device, and an energy storage device.

16. A method for manufacturing a secondary battery electrode, the method comprising:
(a) preparing an electrode slurry by adding a binder and an electrode active material to a solvent; and
(b) obtaining the electrode by applying the electrode slurry, wherein the binder includes a cationic monomer, a crosslinking monomer containing a multifunctional group, and a linear polymer.

17. The method for manufacturing a secondary battery electrode according to claim 16,
wherein the electrode slurry further includes a curing agent.

18. The method for manufacturing a secondary battery electrode according to claim 16,
the method further comprising (c) a step of heat-treating the coated electrode slurry at 25 to 120° C. after the step (b).

19. A secondary battery electrode binder comprising a cationic semi-interpenetrating network polymer (semi-IPN),
wherein the cationic semi-interpenetrating network polymer (semi-IPN) comprises a crosslinked polymer and a linear polymer,
where the crosslinked polymer is obtained by polymerizing a cationic monomer and a multifunctional crosslinking monomer, and
wherein the cationic monomer comprises both (vinylbenzyl)trimethylammonium chloride and 1-methyl-1-(4-nitrobenzyl) piperidinium chloride.

20. A secondary battery electrode binder comprising a cationic semi-interpenetrating network polymer (semi-IPN),
wherein the cationic semi-interpenetrating network polymer (semi-IPN) comprises a crosslinked polymer and a linear polymer,
where the crosslinked polymer is obtained by polymerizing a cationic monomer and a multifunctional crosslinking monomer, and
wherein the cationic monomer comprises both 1-vinyl-3-allylimidazolium bis(trifluoromethanesulfonyl)imide (VAI-TFSI) and 1,3-bis(2,4,6-trimethylphenyl)imidazolium chloride.
